(19) United States
(12) Patent Application Publication
(10) Pub. No.: US 2025/0034027 A1
(43) Pub. Date: Jan. 30, 2025

(54) METHOD FOR PREPARING GLASS NANOSTRUCTURES AND NANOSTRUCTURED SUBSTRATES THEREOF

(71) Applicant: CORNING INCORPORATED, CORNING, NY (US)

(72) Inventors: Eric Emil Leonhardt, Horseheads, NY (US); Mingxiao Li, Annandale, NJ (US); Christian Wilhelm Pester, State College, PA (US); Sai Dileep Kumar Seera, State College, PA (US)

(21) Appl. No.: 18/769,772

(22) Filed: Jul. 11, 2024

Related U.S. Application Data
(60) Provisional application No. 63/528,219, filed on Jul. 21, 2023.

(51) Int. Cl. C03C 1/00; B82Y 30/00; B82Y 40/00; G01N 23/2273

(52) U.S. Cl. CPC C03C 1/00; B82Y 30/00; B82Y 40/00; G01N 23/2273; C03C 2203/52

(57) ABSTRACT

A method of forming a nanostructure, comprising: providing a first polymeric brush structure attached to at least one surface of a substrate, wherein the first polymeric brush structure comprises a pre-glass polymerizable precursor; and curing the first polymeric brush structure to form a nanostructure comprising glass. The first polymeric brush structure can be formed by reacting (i) at least one vinyl-containing group comprising a pre-glass precursor with (ii) a polymerization active group on the linker comprising a reversible addition-fragmentation chain-transfer (RAFT) agent or an atom transfer radical polymerization (ATRP) initiator. The present disclosure further relates to a substrate, comprising: a surface comprising a plurality of nanostructures comprising glass, wherein at least a portion of the nanostructures comprises a detectable amount of carbon by x-ray photoelectron spectroscopy (XPS).

### CROSS-REFERENCE TO RELATED APPLICATIONS

This application claims the benefit of priority of U.S. Provisional Patent Application Ser. No. 63/528,219, filed on Jul. 21, 2023, the content of which is relied upon and incorporated herein by reference in its entirety.

### BACKGROUND

The surface nanotexturing of glass enables several technologies, including hydrophobic/oleophobic antiwetting surfaces (e.g., easy-to-clean surfaces), antireflection and antiglare coatings, metasurfaces and waveguides, and display surfaces with enhanced tactile properties. Methods for obtaining micro- and nanostructured surfaces can largely be divided into two categories: subtractive and additive methodologies. Most commonly, subtractive methods are used that involve an etching step in which part of the surface is removed. Examples of etching methods include reactive ion etching, chemical etching, and laser etching. To obtain a distinct nanopattern rather than a random or statistically roughened surface, an additional, separate masking step is needed which typically involves the deposition and/or nanopatterning of a sacrificial layer by an additive method.

Additive methods specifically for the nanopatterning of glass features necessarily contain the deposition/nanopatterning of a glass-forming precursor, followed by a reaction that converts and consolidates these precursors into their respective glass components. Several additive techniques have been demonstrated for this type of surface patterning, including bulk physical embossing/imprinting, nanoimprint lithography, inkjet printing, and two photon polymerization (TPP), however each of these techniques has limitations. For embossing and nanoimprint lithography, the surface pattern that can be achieved is limited by the scale at which the master can be fashioned, as well as the fidelity of pattern transfer. Nanoscale features are not practical in an embossing process. For nanoimprint lithography, nanoscale features can be achieved with 3D control, however the stamps have a significantly limited lifetime and must be discarded and remade after being used fewer than fifty times, which makes large-scale production an expensive and tedious process. Inkjet printing is a fairly inexpensive and fast process but cannot easily achieve nanoscale features, and controlling the height of features is particularly challenging. Two photon polymerization can easily control the features in three dimensions and can access nanoscale features, however it is a slow, iterative process that involves the rastering of a light source across the surface to achieve the pattern. Therefore, it is expensive and not practical for large-scale production.

Thus, there is a need for alternative methods and structures.

### BRIEF SUMMARY

The present disclosure relates to a method of forming a nanostructure, comprising:
providing a first polymeric brush structure attached to at least one surface of a substrate, wherein the first polymeric brush structure comprises a pre-glass polymerizable precursor; and curing the first polymeric brush structure to form a nanostructure comprising glass.

In some aspects, the first polymeric brush structure is attached to the at least one surface of the substrate through a surface anchoring group on the first polymeric brush structure. In some aspects, prior to attachment, the surface anchoring group is a silyl, hydroxy, thiol, alkenyl, alkynyl, alkoxy, carboxy, hydroxamic acid, amino, azido, halide, phosphono, or sulfonato. In some aspects, prior to attachment, the surface anchoring group is a silyl of the formula SiRₓA_{y}B, where R is a non-reactive group, A is a group that can react with the surface of the substrate, B is a pendant group capable of participating in a coupling reaction, x is an integer of 0, 1, or 2, y is an integer of 1, 2, or 3, wherein x+y=3.

In some aspects, the substrate comprises at least one reactive group on the at least one surface and comprises a glass, a metal oxide, a metal, carbon, silicon, a polymer, or any combination thereof.

In some aspects, the pre-glass polymerizable precursor is connected to the surface anchoring group by a linker. In some aspects, the linker comprises an alkyl chain optionally substituted with (e.g., within the backbone of the alkyl chain or pendant thereto) one or more heteroatoms selected from NH, O, S, C(O), and any combination thereof. In some aspects, the linker is a C₁-C₁₀ alkyl chain.

In some aspects, the first polymeric brush structure is formed by a photoelectron transfer polymerization process comprising a photoredox catalyst. In some aspects, the first polymeric brush structure is formed by reacting (i) at least one vinyl-containing group comprising a pre-glass precursor with (ii) a polymerization active group on the linker comprising a reversible addition-fragmentation chain-transfer (RAFT) agent or an atom transfer radical polymerization (ATRP) initiator.

In some aspects, the RAFT agent comprises a dithioester, a dithiocarbamate, a trithiocarbonate moiety, or a xanthate.

In some aspects, the ATRP initiator comprises a halide selected from chloride, bromide, or iodide. In some aspects, the ATRP initiator is a residue of 2-bromopropanitrile (BPN), 2-chloropropanitrile (CIPN), 2-bromoacetonitrile (BrAN), 2-chloroacetonitrile (ClAN), ethyl 2-bromoisobutyrate (BriB), ethyl 2-bromopropionate (EBrP), methyl 2-bromopropionate (MBrP), 1-phenyl ethylbromide (1-PEBr), tosyl chloride (TsCl), 1-cyano-1-methylethyldiethyldithiocarbamate (MANDC), 2-(N,N-diethyldithiocarbamyl)-isobutyric acid ethyl ester (EMADC), dimethyl 2,6-dibromoheptanedioate (DMDBHD), benzyl chloride (BzCl), benzyl bromide (BzBr), 1-chloro-1-phenylethane (PECl), 1-bromo-1-phenylethane (PEBr), methyl 2-chloro-2-methylpropanoate, methyl 2-bromo-2-methylpropanoate, ethyl 2-chloro-2-methylpropanoate, ethyl 2-bromo-2-methylpropanoate, allyl chloride, allyl bromide, ethyl 2-bromo-2-phenylacetate (EBPA), ethyl 2-bromo-2-phenylacetate (ECPA), ethyl 2-chloro-2-phenylacetate, methyl 2-iodopropanoate (MIP), tert-butyl 2-bromopropanoate (tBBrP), methyl 2-bromoacetate (MBrAc), methyl 2-chloroacetate (MClAc), methyl-2-bromopropanoate (MBrP), 1-bromo-4-(1-bromoethyl)benzene, (1-bromoethyl)benzene, vinyl-2-chloroacetate, diethyl 2-bromo-2-methylmalonate (DBMM), 3-hydroxypropyl 2-bromo-2-methylpropanoate (HPBIB), or 3-bromodihydrofuran-2(3H)-one.

In some aspects, the at least one vinyl-containing group is styrene, acrylate, methacrylate, acrylamide, methacrylamide, vinyl ester, vinyl amide, or any combination thereof. In some aspects, the vinyl-containing group is methacrylate.

In some aspects, the pre-glass precursor is silicon-based, titanium-based, zirconium-based, aluminum-based, cerium-based, or any combination thereof. In some aspects, the pre-glass precursor comprises SiOx, TiOx, ZrOx, or any combination thereof. In some aspects, the pre-glass precursor comprises a silsesquioxane. In some aspects, the pre-glass polymerizable precursor is a polyoctahedral silsesquioxane (POSS) comprising at least one vinyl-containing group.

In some aspects, the photoredox catalyst comprises ruthenium, copper, iridium, or zinc. In some aspects, the photoredox catalyst comprises at least one ligand selected from 2,2′-bipyridine (bpy), 4,4′-dimethyl-2,2′-dipyridine, 4,4′-di-tert-butyl-2,2′-dipyridine, 4,4′-diethylester-2,2′-bipyridine, 2-phenylpyridine (ppy), 2-(2,4-difluorophenyl)-5-(trifluoromethyl)pyridine (dF(CF₃)ppy), 2-(2,4-difluorophenyl) pyridine, 4-(tert-butyl)-2-[4-(tert-butyl)phenyl]pyridine (dtbbpy), 4-methyl-2-(4-methylphenyl)pyridine, bis(pyrazolyl)methane, 2,2′-bipyrazine (bpz), 1,10-phenanthroline, 4,7-dichloro-1,10-phenanthroline, 4,7-dimethoxy-1,10-phenanthroline, 7,8-benzoquinoline, a phenylporphyrin, and any combination thereof. In some aspects, the photoredox catalyst comprises Ru(bpy)₃²⁺, Ru(bpz)₃²⁺, Ir(ppy)₃, Ir(ppy)₂(dtbbpy)⁺, Ir[dF(CF₃)ppy]₂(dtbbpy)⁺, or zinc tetraphenylporphyrin (Zn-TPP).

In some aspects, the curing comprises using heat, reactive plasma, or both heat and reactive plasma.

In some aspects, the nanostructure is substantially free of carbon. In some aspects, the nanostructure comprises a detectable amount of carbon, up to about 20 atomic %. In some aspects, the nanostructure comprises a detectable amount up to about 10 atomic % or less of carbon.

In some aspects, the method further comprises forming the first polymeric brush structure by contacting (i) at least one vinyl-containing group comprising a pre-glass precursor with (ii) a polymerization active group comprising a reversible addition-fragmentation chain-transfer (RAFT) agent or an atom transfer radical polymerization (ATRP) initiator, in the presence of a redox catalyst;
optionally further comprising attaching the polymerization active group to a linker; and
optionally further comprising attaching the linker to the at least one surface of the substrate by reacting a surface anchoring group attached to the linker with at least one reactive group on the at least one surface.

In some aspects, the method comprises providing a second polymeric brush structure, wherein the first polymeric brush structure is different from the second polymeric brush structure, and then curing both the first polymeric brush structure and the second polymeric brush structure.

In some aspects, the method further comprises coating the nanostructure and substrate with a silane.

The present disclosure also relates to a substrate, comprising:
a surface comprising a plurality of nanostructures comprising glass,
wherein at least a portion of the nanostructures comprises a detectable amount of carbon by x-ray photoelectron spectroscopy (XPS).

In some aspects, the detectable amount of carbon is less than 20 atomic %.

In some aspects, the nanostructures have an average diameter of about 1 nm to about 10 μm. In some aspects, the nanostructures have an average height of about 1 nm to about 300 nm. In some aspects, the nanostructures have an average height of about 10 nm to about 200 nm.

In some aspects, the plurality of nanostructures are formed by a method described herein.

Additional aspects and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### BRIEF DESCRIPTION OF THE DRAWINGS

FIG. 1 shows exemplary RAFT agents.

FIG. 2 is an illustration of a surface-initiated photoelectron transfer reversible addition-fragmentation chain-transfer (SI-PET-RAFT) polymerization using methacrylate-POSS attached to a substrate through a polymeric brush structure, in which R is POSS.

FIG. 3 is a graph of thickness (nm) as a function of total reaction time (h).

FIG. 4 is a height profile of height (nm) versus position (μm) of a film grown by SI-PET-RAFT both before (solid line) and after (dotted line) curing.

FIG. 5 is an x-ray photoelectron (XPS) spectrum of counts (s⁻¹) versus binding energy (eV) for peaks associated with carbon species for a POSS-acrylate film grown by SI-PET-RAFT and the corresponding cured SiOx glassy film.

FIG. 6 is a ToF-SIMS negative ion spectrum of intensity (counts) versus m/z for a film grown by SI-PET-RAFT both before and after curing.

FIGS. 7A and 7B are negative ion depth-profiling ToF-SIMS spectra for a film grown by SI-PET-RAFT before curing (FIG. 7A) and after curing (FIG. 7B).

FIG. 8 is an illustration of a surface-initiated atom transfer radical polymerization (SI-ATRP) via light mediation using methacrylate-POSS attached to a substrate through a polymeric brush structure, in which R is POSS.

FIG. 9 is a graph of average brush thickness (nm) as a function of irradiation time (min).

FIG. 10 is a height profile of height (nm) versus position (μm) of a film grown by SI-ATRP both before (solid line) and after (dotted line) curing.

### DETAILED DESCRIPTION

The headings provided herein are not limitations of the various aspects of the disclosure, which can be defined by reference to the specification as a whole. It is also to be understood that the terminology used herein is for the purpose of describing particular aspects only, and is not intended to be limiting, since the scope of the present disclosure will be limited only by the appended claims.

### Definitions

For convenience, the meaning of some terms and phrases used in the specification, examples, and appended claims are provided below. Unless stated otherwise, or implicit from context, the following terms and phrases include the meanings provided below. The definitions are provided to aid in describing particular aspects, and are not intended to limit the claimed technology, because the scope of the technology is limited only by the claims. Unless otherwise defined, all technical and scientific terms used herein have the same meaning as commonly understood by one of ordinary skill in the art to which this technology belongs. If there is an apparent discrepancy between the usage of a term in the art and its definition provided herein, the definition provided within the specification will control.

The articles “a,” “an,” and “the” are used herein to refer to one or to more than one (i.e., to at least one) of the grammatical object of the article. By way of example, “an element” means one element or more than one element.

As used herein, the term “about” means within an acceptable error range for the particular value as determined by one of ordinary skill in the art, which depends in part on how the value is measured or determined, i.e., the limitations of the measurement system. For example, “about” can mean within 3 or more than 3 standard deviations, per the practice in the art. Alternatively, “about” can mean a range of up to 10% (e.g., up to 5% or up to 1%) of a given value.

The term “at least” prior to a number or series of numbers is understood to include the number associated with the term “at least,” and all subsequent numbers or integers that could logically be included, as clear from context. When “at least” is present before a series of numbers or a range, it is understood that “at least” can modify each of the numbers in the series or range. For example, “at least 3” means at least 3, at least 4, at least 5, etc. When at least is present before a component in a method step, then that component is included in the step, whereas additional components are optional.

As used herein, the terms “comprises,” “comprising,” “having,” “including,” “containing,” and the like are open-ended terms meaning “including, but not limited to.” To the extent a given aspect disclosed herein “comprises” certain elements, it should be understood that present disclosure also specifically contemplates and discloses aspects that “consist essentially of” those elements and that “consist of” those elements.

As used herein the terms “consists essentially of,” “consisting essentially of,” and the like are to be construed as a semi-closed terms, meaning that no other ingredients which materially affect the basic and novel characteristics of an aspect are included.

As used herein, the terms “consists of,” “consisting of,” and the like are to be construed as closed terms, such that an aspect “consisting of” a particular set of elements excludes any element, step, or ingredient not specified in the aspect.

As used herein, the term “glass” refers to a solid comprising an amorphous phase and optionally comprising one or more crystalline phases. A glass can be defined herein to contain only an amorphous phase, or can be defined herein to further comprise one or more crystalline phases In some aspects, a glass can comprise, e.g., silica, titania, alumina, zirconia, ceria, or combinations thereof. In some aspects, a glass can comprise silica.

As used herein, components are “immobilized” or “attached” to a substrate, for example, when the components are covalently bound, ionically bound, electrostatically bound, or coordinatively bound to at least one surface of a substrate, which reduces or precludes mobility. In some aspects components are immobilized by being covalently bound to a substrate.

As used herein, the term “linker” refers to a combination of structural elements comprising linkages (e.g., covalent bonds) that connect two components, such as at least one surface of a substrate and a polymeric brush structure.

As used herein, the term “nanostructure” refers to a nano-sized glass-containing structure non-leachably disposed on a substrate. In some aspects, a nanostructure ranges in size between about 1 nm to about 400 nm (e.g., about 1 nm to about 300 nm, about 1 nm to about 100 nm) in at least one direction.

As used herein, the term “non-leachable” or a compound that is “non-leachably disposed” is meant to define a compound that is affixed on a substrate such that it does not substantially diffuse away from the substrate.

As used herein, the term “non-reactive group” is a chemical group of a molecule (e.g., a polymer, a polymeric brush structure, a polymerization active group, a linker, etc.) that is not readily chemically reactive with another compound without, for example, severe conditions and/or catalysis. Non-reactive groups include, for example, alkyl and acetyl.

As used herein, the term “patterning the substrate” refers to method steps, as described herein, for forming nanoscale features on a substrate with three-dimensional control over features and direct control over the feature topography in a single patterning step. The method steps can include providing a first polymeric brush structure attached to at least one surface of a substrate and curing the first polymeric brush structure to form a nanostructure comprising glass. Additional optional steps can include one or more of: forming the first polymeric brush structure by contacting (i) at least one vinyl-containing group comprising a pre-glass precursor with (ii) a polymerization active group comprising a reversible addition-fragmentation chain-transfer (RAFT) agent or an atom transfer radical polymerization (ATRP) initiator, in the presence of a redox catalyst; attaching the polymerization active group to a linker; attaching a linker to at least one surface of the substrate by reacting a surface anchoring group attached to the linker with at least one reactive group on the at least one surface; providing a second polymeric brush structure; curing both the first polymeric brush structure and the second polymeric brush structure; and coating the nanostructure and substrate with a silane.

As used herein, the term “polymeric brush structure” refers to a component that comprises a pre-glass polymerizable precursor. In some aspects, the polymeric brush structure can have a pre-glass polymerizable precursor bound to a polymer portion that is bound to a linker, wherein the linker is bound to a surface anchoring group that can bind to a reactive group on a surface of a substrate.

As used herein, the term “pre-glass polymerizable precursor” refers to a reactive moiety that can be polymerized and then cured to form a glass. In some aspects, the pre-glass polymerizable precursor comprises at least one vinyl-containing group comprising a pre-glass precursor.

As used herein, the term “pre-glass precursor” refers to a moiety that can be cured to form a glass. In some aspects, the pre-glass precursor can be silicon-based (e.g., SiOx), titanium-based (e.g., TiOx), zirconium-based (e.g., ZrOx), aluminum-based (e.g., AlOx), cerium-based (e.g., CeOx), or any combination thereof.

As used herein, the term “reactive group” is a functional group of a molecule (e.g., a polymer, a polymeric brush structure, a polymerization active group, a linker, etc.) that can react with another compound to couple at least a portion (e.g., another reactive group) of that other compound to the molecule. Reactive groups include carboxy, activated ester, sulfonyl halide, sulfonate ester, isocyanate, isothiocyanate, epoxy, aziridine, halide, aldehyde, ketone, amine, acrylamide, thiol, acyl azido, acyl halide, hydrazine, hydroxyamine, alkyl halide, imidazole, pyridine, phenol, alkyl sulfonate, halotriazine, imido ester, maleimide, hydrazide, hydroxy, and photo-reactive azido aryl groups. Activated esters, as understood in the art, generally include esters of succinimidyl, benzotriazolyl, or aryl substituted by electron-withdrawing groups such as sulfo, nitro, cyano, or halo groups; or carboxylic acids activated by carbodiimides.

As used herein, the term “silsesquioxane” is an organosilicon compound with the chemical formula [RSiO1.5] n, in which R is H, alkyl, aryl, alkenyl, hydroxy, alkoxy, alkylenyl, arylenyl, or cycloalkyl, and n represents the number of vertices (e.g., n can be an integer from 1 to 12, such as 1, 2, 3, 4, 5, 6, 7, 8, 9, 10, 11, or 12). Every silicon atom is connected to each other via siloxane linkages (Si—O—Si) and bonded to an organic R group. Silsesquioxanes can adopt well-defined three-dimensional polyhedral “cage” structures with different sizes (e.g., 6, 8, 10, or 12 vertices), or “noncage” structures, including “partial- or open-cage” and polymeric two-dimensional ladder structures. An example of a silsesquioxane is polyoctahedral silsesquioxane (POSS).

As used herein, the term “substantially free of” means that a composition contains little or no specified ingredient/component, such as less than about 5 wt %, less than about 4 wt %, less than about 3 wt %, less than about 2 wt %, less than about 1 wt %, less than about 0.5 wt %, less than about 0.3 wt %, less than about 0.2 wt %, less than about 0.1 wt %, or about 0 wt % of the specified ingredient. In an aspect, “substantially free of carbon” can refer to a nanostructure that contains less than about 5 atomic %, less than about 4 atomic %, less than about 3 atomic %, less than about 2 atomic %, less than about 1 atomic %, less than about 0.5 atomic %, less than about 0.3 atomic %, less than about 0.2 atomic %, less than about 0.1 atomic %, or about 0 atomic % of carbon.

As used herein, the term “substituted” functional group (e.g., substituted alkyl, alkenyl, alkoxy, aryl) includes at least one substituent (e.g., 1, 2, 3, 4, or 5) that can be, for example, alkyl, halo, cyano, alkoxy, thiol, aryl, alkoxycarbonyl, alkylaminocarbonyl, dialkylaminocarbonyl, hydroxy, amino, alkylamino, dialkylamino, trialkylammonium, alkanoylamino, arylcarboxamido, hydrazino, alkylthio, alkenyl, and a reactive group, as described herein.

As used herein, the term “substrate” is an underlying substance or layer that is a basis for polymeric brush structures to attach. The substrate can be any suitable material, such as a glass, a metal oxide, a metal, carbon, silicon, a polymer, or any combination thereof.

The substrate includes (either naturally or as chemically modified) one or more reactive groups at the surface to react with a surface anchoring group on the polymeric brush structure.

A “substituted” functional group (e.g., substituted alkyl, alkenyl, alkoxy, aryl) includes at least one substituent (e.g., 1, 2, 3, 4, or 5) that can be, for example, halo, cyano, alkoxy, thiol, aryl, alkoxycarbonyl, alkylaminocarbonyl, dialkylaminocarbonyl, hydroxy, amino, alkylamino, dialkylamino, trialkylammonium, alkanoylamino, arylcarboxamido, hydrazino, alkylthio, alkenyl, or a reactive group, as described herein.

As used herein, the term “alkylenyl” refers to a divalent (diradical) alkyl group, wherein alkyl is defined herein. In some aspects, an alkylenyl group will have from 1 to 15 carbon atoms (e.g., 1 to 10 carbon atoms, 1 to 8 carbon atoms, 1 to 6 carbon atoms, 1 to 4 carbon atoms, 1 to 3 carbon atoms, or 1 to 2 carbon atoms).

As used herein, the term “alkyl” refers to a straight-chain or branched alkyl substituent containing from, for example, from about 1 to about 10 carbon atoms (C₁₋₁₀ alkyl), e.g., about 1 to about 6 carbon atoms, from about 1 to about 4 carbon atoms, or about 1 to about 3 carbons. Examples of alkyl group include, but are not limited to, methyl, ethyl, n-propyl, isopropyl, n-butyl, sec-butyl, isobutyl, tert-butyl, n-pentyl, isopentyl, n-hexyl, and the like. This definition also applies wherever “alkyl” occurs as part of a group, such as, e.g., C₁₋₆ haloalkyl (e.g., -trifluoromethyl (—CF₃)).

As used herein, the term “alkenyl” refers to a linear alkenyl substituent containing from, for example, 2 to about 6 carbon atoms (C₂₋₆ alkenyl), in which branched alkenyls are about 3 to about 6 carbons atoms (C₃₋₆ alkenyl). In accordance with an aspect, the alkenyl group can be a C₂₋₄ alkenyl. Examples of alkenyl group include, but are not limited to, cthenyl, allyl, 2-propenyl, 1-butenyl, 2-butenyl, 1-pentenyl, 2-pentenyl, 3-pentenyl, 1-hexenyl, and the like.

As used herein, the term “aryl” refers to a C₆₋₃₀ aromatic compound comprising a mono-, bi-, or tricyclic carbocyclic ring system having one, two, or three aromatic rings, for example, phenyl, naphthyl, anthracenyl, or biphenyl. The aromatic compound generally contains from, for example, 6 to 30 carbon atoms, from 6 to 18 carbon atoms, from 6 to 14 carbon atoms, or from 6 to 10 carbon atoms. It is understood that the term aryl includes carbocyclic and/or heterocyclic moieties that are planar and comprise 4n+2π electrons, according to Hückel's Rule, wherein n=1, 2, or 3.

As used herein, the term “alkoxy” refers to an alkyl group bonded to an oxygen. In some aspects, the alkoxy has the structure-OR, in which R is a C₁₋₆ alkyl group (C₁₋₆ alkoxy).

As used herein, the term “alkynyl” refers to a linear alkynyl substituent containing from, for example, 2 to about 6 carbon atoms (C₂₋₆ alkynyl), in which branched alkynyls are about 3 to about 6 carbons atoms (C₃₋₆ alkynyl). In accordance with an aspect, the alkynyl group is a C₂₋₄ alkynyl. Examples of alkynyl group include, but are not limited to, ethynyl, propynyl, 1-butynyl, 2-butynyl, 1-pentynyl, 2-pentynyl, 3-pentynyl, 1-hexynyl, and the like.

As used herein, the terms “halide” and “halo” refer to —F, —Cl, —Br, or —I.

As used herein, the term “hydroxy” refers to —OH.

As used herein, the term “thiol” refers to —SH.

As used herein, the term “carboxy” refers to —C(O)OH.

As used herein, the term “hydroxamic acid” refers to —C(O)NR—OH, in which R is H or alkyl, as described herein.

As used herein, the term “azido” refers to —N₃ or —N═N⁺═N⁻.

As used herein, the term “silyl” refers to —SiR₃, in which each R group is the same or different and each is a non-reactive group or a reactive group, so long as at least one R group is a reactive group (e.g., hydrogen, halide, alkenyl, alkoxy, amino, isocyanato, hydroxy, epoxy, etc.). Non-reactive groups can include, for example, an alkyl, such as C₁₋₆ alkyl.

As used herein, the term “epoxy” refers to a cyclic moiety of formula —CH₂—O—CH₂—.

As used herein, the term “phosphono” refers to —P(O)(OH)₂.

As used herein, the term “sulfonato” refers to —S(O)₂OH.

As used herein, the term “nitro” refers to —NO₂.

As used herein, the term “cyano” refers to —CN.

As used herein, the term “isocyanato” refers to —N═C═O.

As used herein, the term “amino” refers to —NH₂. The terms mono- and di-alkylamino refer to a nitrogen bonded to one or two alkyl groups, respectively, i.e., —NHR or —NRR′, in which R and R′ are the same or different alkyl groups (e.g., each C₁₋₆ alkyl).

As used herein, the term “aryloxy” refers to an aryl group bonded to an oxygen, i.e., —O(Ar), in which Ar is a C₆₋₁₀ aryl group, such as phenoxy.

As used herein, the term “alkylcarboxy” refers to a carboxy group wherein the hydrogen bound to the carboxy group has been replaced with a alkyl group, i.e., —C(O)OR, wherein R is an alkyl group (e.g., C₁₋₆ alkyl group).

As used herein, the term “amido” refers to the structure —C(O)NH or —NHC(O). The term “alkylamido” refers to —C(O)NR or —NRC(O), wherein R is an alkyl group (e.g., C₁₋₆ alkyl).

### Methods of the Disclosure

It was discovered that a top-down, synchronous process can be provided that simultaneously offers three-dimensional control over nanoscale features and direct control over the feature topography in a single patterning step. In particular, the present disclosure relates to a method of forming a nanostructure, comprising:
providing a first polymeric brush structure attached to at least one surface of a substrate, wherein the first polymeric brush structure comprises a pre-glass polymerizable precursor; and
curing the first polymeric brush structure to form a nanostructure comprising glass.

The polymeric brush structure can be any suitable structure that comprises a pre-glass polymerizable precursor (e.g., pre-glass precursor+polymerizable group). In some aspects, the polymeric brush structure can comprise a pre-glass precursor bound to a polymer portion that is bound to a linker, which is bound to a surface anchoring group to form one of the following structures:
surface anchoring group-linker-pre-glass polymerizable precursor; or
surface anchoring group-linker-polymer-pre-glass precursor.

In some aspects, the polymeric brush structure can have the structure:
surface anchoring group-linker-polymerization active group-polymer-pre-glass precursor.

In some aspects, the polymeric brush structure can have the structure:
surface anchoring group-linker-RAFT agent-polymer-pre-glass precursor; or
surface anchoring group-linker-ATRP initiator-polymer-pre-glass precursor.

In some aspects, the polymeric brush structure (e.g., first polymeric brush structure, second polymeric brush structure) can be attached to the at least one surface of the substrate through a surface anchoring group on the polymeric brush structure. In some aspects, prior to attachment to a substrate, the surface anchoring group can be any suitable reactive group that can react with a reactive group on the surface of the substrate. For example, prior to attachment to a substrate, the surface anchoring group can be a silyl, hydroxy, thiol, alkenyl, alkynyl, alkoxy, carboxy, hydroxamic acid, amino, azido, halide, phosphono, sulfonate, or any combination thereof. In some aspects, the surface anchoring group can be at a terminal position on the polymeric brush structure (e.g., first polymeric brush structure, second polymeric brush structure). In other aspects, the surface anchoring group can be at a non-terminal position on the polymeric brush structure (e.g., first polymeric brush structure, second polymeric brush structure).

In some aspects, prior to attachment to a substrate, the surface anchoring group can be a silyl of the formula SiRₓA_{y}B, where R is a non-reactive group, A is a group that can react with the surface of the substrate, B is a reactive, pendant group capable of participating in a coupling reaction (e.g., a coupling reaction with a linker), x is an integer of 0, 1, or 2, y is an integer of 1, 2, or 3, wherein x+y=3. Suitable reactive groups are described herein and include, e.g., carboxy, activated ester, sulfonyl halide, sulfonate ester, isocyanate, isothiocyanate, epoxy, aziridine, halide, aldehyde, ketone, amine, acrylamide, thiol, acyl azide, acyl halide, hydrazine, hydroxyamine, alkyl halide, imidazole, pyridine, phenol, alkyl sulfonate, halotriazine, imido ester, maleimide, hydrazide, hydroxy, and photo-reactive azido aryl groups. In some aspects, each A and B can be independently selected from the group consisting of hydrogen, halide, alkenyl, alkynyl, alkoxy, carboxy, hydroxamic acid, amino, isocyanato, hydroxy, epoxy, thiol, azido, halide, phosphono, sulfonate, and combinations thereof. In some aspects, each A and B can be independently selected from the group consisting of hydrogen, halide, alkenyl, alkoxy, amino, isocyanato, hydroxy, epoxy, and combinations thereof. In some aspects, R is an alkyl.

In some aspects, the substrate can comprise at least one reactive group on the at least one surface. The reactive group is as described herein and can include, for example, carboxy, activated ester, sulfonyl halide, sulfonate ester, isocyanate, isothiocyanate, epoxy, aziridine, halide, aldehyde, ketone, amine, acrylamide, thiol, acyl azide, acyl halide, hydrazine, hydroxyamine, alkyl halide, imidazole, pyridine, phenol, alkyl sulfonate, halotriazine, imido ester, maleimide, hydrazide, hydroxy, and photo-reactive azido aryl groups. In some aspects, the at least one reactive group on the substrate surface can be silyl, halide, alkenyl, alkynyl, alkoxy, carboxy, hydroxamic acid, amino, isocyanato, hydroxy, epoxy, thiol, azido, halide, phosphono, sulfonate, or any combination thereof. Typically, the at least one surface will have multiple reactive groups. If a reactive group is not already present on at least one surface, the substrate can be chemically modified to include at least one (e.g., multiple) reactive groups on a surface.

The substrate can be any suitable base that can withstand the processing steps, including a polymerization step and curing step. In some aspects, the substrate can comprise a glass, a metal oxide, a metal, carbon, silicon, a polymer, or any combination thereof. In some aspects, the substrate is not porous.

A glass substrate can be any suitable substrate, such as a glass based on silica (e.g., based on SiO₂), zirconate (e.g., based on ZrO₂), zincate (e.g., based on ZnO), aluminate (e.g., based on Al₂O₃), germanate (e.g., based on GeO₂), tellurite (e.g., based on TeO₂), antimonate (e.g., based on Sb₂O₃), arsenate (e.g., based on As₂O₃), titanate (e.g., based on TiO₂), tantalate (e.g., based on Ta₂O₅), or any combination thereof. Mixed metal oxides include, e.g., zinc iron chromite, iron chromite, nickel antimony titanate, chrome antimony titanium buff, chromium green, cobalt chromite, cobalt titanate, chromium green-black, copper chromite black, chrome iron nickel black, cobalt aluminate, cobalt chromium aluminate, and zinc ferrite.

A metal oxide substrate can be any suitable substrate based on silica, alumina, titania, zirconia, zinc oxide, germania, tellurium oxide, antimony oxide, arsenic oxide, titanium dioxide, tantalum oxide, iron oxide, cobalt oxide, chrome oxide, copper oxide, manganese dioxide, nickel oxide, or any combination thereof.

A metal substrate can be any suitable substrate based on zinc, gold, silver, aluminum, copper, tin, brass, chrome, stainless steel, alloy thereof, or any combination thereof.

A carbon substrate can be any suitable substrate based on carbon. Examples of a carbon substrate include, e.g., graphene, graphene oxide, glassy (vitreous) carbon, a carbide (e.g., boron carbide, chromium carbide, hafnium carbide, molybdenum carbide, niobium carbide, silicon carbide, tantalum carbide, titanium carbide, tungsten carbide, vanadium carbide, or zirconium carbide), or any combination thereof.

A silicon substrate can be any suitable substrate based on silicon. Examples of a silicon substrate include, e.g., a silicon wafer (e.g., crystalline silicon), a silicon carbide, a silicon nitride, a silicon oxynitride, a silicide (e.g., chromium silicide, cobalt silicide, hafnium silicide, molybdenum silicide, nickel silicide, niobium silicide, tantalum silicide, titanium silicide, tungsten silicide, vanadium silicide, or zirconium silicide), or any combination thereof.

A polymer substrate can be any suitable substrate based on any suitable polymer, such as polyolefin (e.g., polyethylene, polypropylene), polyester (e.g., polyester terephthalate), polytetrafluoroethylene (PTFE), polydimethylsiloxane (PDMS), polysulfone, polyacrylate, polyacrylamide, poly(ether ether ketone) (PEEK), poly(4,4′-oxydiphenylene pyromellitimide), polyvinyl chloride (PVC), polyaniline, polyamine, polyurethane, polycarbonate, or any combination thereof.

The dimensions, including the thickness and shape, of the substrate are not particularly limited. In some aspects, at least one dimension of the substrate can be about 0.1 mm or more, about 1 mm or more, about 10 mm or more, about 50 mm or more, about 100 mm or more, about 200 mm or more, or about 500 mm or more. In some aspects, the upper limit of at least one dimension of the substrate can be about 100 cm or less, about 90 cm or less, about 80 cm or less, about 70 cm or less, about 60 cm or less, about 50 cm or less, about 40 cm or less, about 30 cm or less, about 20 cm or less, about 10 cm or less, about 1 cm or less, or about 1 mm or less. In some aspects, at least one dimension of the substrate can be about 0.1mm to about 1,000 mm, about 0.1 mm to about 1 mm, about 0.1 mm to about 3 mm, about 10 mm to about 1,000 mm, about 50 mm to about 1,000 mm, about 100 mm to about 1,000 mm, about 200 mm to about 1,000 mm, or about 500 mm to about 1,000 mm.

In some aspects, the pre-glass polymerizable precursor can be connected to the surface anchoring group via a linker (e.g., a bifunctional linker). In some aspects, the linker can comprise an alkyl chain optionally substituted with (e.g., within the backbone of the alkyl chain or pendant thereto) one or more heteroatoms selected from NH, O, S, C(O), and any combination thereof. For example, the alkyl chain can be an alkylenyl of the formula —(CH₂)ₙ—, in which n is an integer from 1 to 20 (i.e., 1, 2, 3, 4, 5, 6, 7, 8, 9, 10, 11, 12, 13, 14, 15, 16, 17, 18, 19, or 20, or any range formed therefrom). In some aspects, n can be an integer from 1 to 10 (e.g., from 1 to 8, 1 to 6, 1 to 5, 1 to 4, 1 to 3, or 1 to 2). In some aspects, the alkylenyl chain can have one or more (e.g., 1, 2, 3, 4, 5, 6, 7, or 8, or any range formed therefrom) heteroatoms selected from NH, O, S, C(O), and any combination thereof inserted into the alkyl chain to form, for example, an amino (—NH—), ether (—O—), sulfo (—S—), keto (—C(O)—), amido (—NHC(O)— or —C(O)NH—), ester (—C(O)O— or —OC(O)—), or thioester (—C(O)S— or —SC(O)—) linkage. In some aspects, the alkyl chain can be unsubstituted. In other aspects, the alkyl chain can be substituted with one or more heteroatoms, as described herein, and/or or one or more (e.g., 1, 2, 3, 4, 5, 6, 7, or 8, or any range formed therefrom) pendant groups, such as alkyl, halo, cyano, alkoxy, thiol, aryl, alkoxycarbonyl, alkylaminocarbonyl, dialkylaminocarbonyl, hydroxy, amino, alkylamino, dialkylamino, trialkylammonium, alkanoylamino, arylcarboxamido, hydrazino, alkylthio, alkenyl, and reactive groups. In some aspects, the linker can be a C₁-C₁₀ alkyl chain, including a C₁-C₁₀ alkyl chain with an ester linkage inserted in the chain with one or two optional substituents (e.g., alkyl, cyano).

In some aspects, the linker can be modified to have one or more reactive groups (e.g., terminal reactive groups) to form a linker (e.g., a bifunctional linker) that can attach to the surface anchoring group and/or the pre-glass polymerizable precursor. Suitable reactive groups are as described herein, and include, an amino reactive moiety (e.g., NHS-ester, p-nitrophenol, isothiocyanate, isocyanate, or aldehyde), a thiol reactive moiety (e.g., acrylate, maleimide, or pyridyl disulfide), a hydroxy reactive moiety (e.g., isothiocyanate or isocyanate), a carboxylic acid reactive moiety (e.g., epoxide), or an azide reactive moiety (e.g., alkyne). Examples of reactive groups include, e.g., carboxy, activated ester, sulfonyl halide, sulfonate ester, isocyanate, isothiocyanate, epoxy, aziridine, halide, aldehyde, ketone, amine, acrylamide, thiol, acyl azide, acyl halide, hydrazine, hydroxyamine, alkyl halide, imidazole, pyridine, phenol, alkyl sulfonate, halotriazine, imido ester, maleimide, hydrazide, hydroxy, and photo-reactive azido aryl groups.

In some aspects, the reactive moiety can be an amine reactive moiety. As used herein the term “amine reactive moiety” refers to a chemical group that can react with a reactive group having an amino moiety, e.g., a primary amine. Exemplary amine reactive moieties include, e.g., N-hydroxysuccinimide esters (NHS-ester), carbamate, isothiocyanate, isocyanate, and aldehyde. In some aspects, an amine reactive moiety can be attached to a terminal position of a linker. In some aspects, the amine reactive moiety can be a NHS-ester. Typically, a NHS-ester reactive moiety can react with a primary amine of a reactive group to yield a stable amide bond and N-hydroxysuccinimide (NHS). In some aspects, the amine reactive moiety can be a carbamate activated with a p-nitrophenol group. Typically, the activated carbamate reacts with a primary amine of a reactive group to yield a stable carbamate moiety and p-nitrophenol as a leaving group. In some aspects, the amine reactive moiety can be an isothiocyanate. Typically, an isothiocyanate reacts with a primary amine of a reactive group to yield a stable thiourea moiety. In some aspects, the amine reactive moiety can be an isocyanate. Typically, an isocyanate reacts with a primary amine of a reactive group to yield a stable urea moiety. In some aspects, the amine reactive moiety can be an aldehyde. Typically, aldehydes react with primary amines to form Schiff bases which can be further reduced to form a covalent bond through reductive amination.

In some aspects, the reactive moiety can be a thiol reactive moiety. As used herein the term “thiol reactive moiety” refers to a chemical group that can react with a reactive group having a thiol moiety (or mercapto group). Exemplary thiol reactive moieties include, e.g., acrylates, maleimides, and pyridyl disulfides. In some aspects, a thiol reactive moiety can be attached to a terminal position of a linker. In some aspects, the thiol reactive moiety can be an acrylate. Typically, acrylates react with thiols at the carbon B to the carbonyl of the acrylate to form a stable sulfide bond. In some aspects, the thiol reactive moiety can be a maleimide. Typically, maleimides react with thiols at either the carbon β or the carbonyls to form a stable sulfide bond. In some aspects, the thiol reactive moiety can be a pyridyl disulfide. Typically, pyridyl disulfides react with thiols at the sulfur atom β to the pyridyl to form a stable disulfide bond and pyridine-2-thione.

In some aspects, the reactive moiety can be a hydroxy reactive moiety. As used herein the term “hydroxy reactive moiety” refers to a chemical group that can react with a reactive group having a hydroxy moiety. Exemplary hydroxy reactive moieties include, e.g., isothiocyanates and isocyanates. In some aspects, a hydroxy reactive moiety can be attached to a terminal position of a linker. In some aspects, the hydroxy reactive moiety can be an isothiocyanate. Typically, an isothiocyanate can react with a hydroxy of a reactive group to yield a stable carbamothioate moiety. In some aspects, the hydroxy reactive moiety can be an isocyanate. Typically, an isocyanate can react with a hydroxy of a reactive group to yield a stable carbamate moiety.

In some aspects, the reactive moiety can be a carboxylic acid reactive moiety. As used herein the term “carboxylic acid reactive moiety” refers to a chemical group that can react with a reactive group having a carboxylic acid moiety. An exemplary carboxylic acid reactive moiety is an epoxide. In some aspects, a carboxylic acid reactive moiety can be attached to a terminal position of a linker. In some aspects, the carboxylic acid reactive moiety can be an epoxide. Typically, an epoxide reacts with the carboxylic acid of a reactive group at either of the carbon atoms of the epoxide to form a 2-hydroxyethyl acetate moiety.

In some aspects, the reactive moiety can be an azide reactive moiety. As used herein the term “azide reactive moiety” refers to a chemical group that can react with a reactive group having an azide moiety. An exemplary azide reactive moiety is an alkyne. In some aspects, an azide reactive moiety can be attached to a terminal position of a linker. In some aspects, the azide reactive moiety can be an alkyne. Typically, an alkyne can react with the azide of a reactive group through a 1,3-dipolar cycloaddition reaction to form a 1,2,3-triazole moiety.

In some aspects, the polymeric brush structure (e.g., first polymeric brush structure, second polymeric brush structure) can be formed by a photoelectron transfer (PET) polymerization process comprising a photoredox catalyst. Examples of a PET polymerization process include, e.g., photoinirferter polymerization and/or controlled/living radical polymerizations (controlled radical polymerizations are also termed “reversible deactivation radical polymerizations”) by photoinduced electron transfer reactions (e.g., atom transfer radical polymerization (ATRP), reversible addition-fragmentation chain-transfer (RAFT), or nitroxide-mediated polymerization (NMP)), cationic polymerization (e.g., photoinitiated cationic polymerization, cationic polymerization with electron transfer with singlet and triplet excited states, cationic polymerization by charge transfer complexes, cationic polymerization by addition-fragmentation agents, photoinduced living cationic polymerization, or cationic ring-opening polymerization), or anionic polymerization (e.g., anionic ring-opening polymerization). In some aspects, the PET polymerization process can be a photoinirferter polymerization and/or controlled/living radical polymerization by photoinduced electron transfer reaction (e.g., ATRP, RAFT). In some aspects, the PET polymerization can be an uncontrolled polymerization process (e.g., free radical polymerization, which includes free radical promoted cationic polymerization).

In some aspects, the photoredox catalyst can comprise a transition metal, such as ruthenium, copper, iridium, or zinc. In some aspects, the photoredox catalyst can comprise ruthenium. In some aspects, the photoredox catalyst can comprise copper. In some aspects, the photoredox catalyst can comprise iridium. In some aspects, the photoredox catalyst can comprise zinc.

In addition to the transition metal, the photoredox catalyst can comprise at least one ligand, which can be monodentate or multidentate (e.g., bidentate, tridentate, tetradentate). Typically the complex will include enough ligands to provide a full coordination sphere. In some aspects, at least one ligand (e.g., 1, 2, 3, 4, 5, or 6) can comprise a nitrogen-containing heterocycle.

Monodentate ligands include, for example, —F, —Cl, —Br, —I, —CN, —SCN, —OH, NH₃, alkylamine, dialkylamine, trialkylamine, alkoxy, a heterocyclic compound, compounds containing such groups, a solvent molecule (e.g., H₂O, EtOH, acetonitrile), or a reactive group. For example, an alkyl (e.g., C₁₋₁₂, C₁₋₆, C₁₋₄, C₁₋₃) or aryl (e.g., phenyl, benzyl, naphthyl) portions of a ligand can be optionally substituted by F, Cl, Br, I, alkylamino, dialkylamino, trialkylammonium (except aryl portions), alkoxy, alkylthio, aryl. Examples of suitable heterocyclic monodentate ligands include imidazole, pyrazole, oxazole, thiazole, pyridine, and pyrazine, each of which can be unsubstituted or substituted, as described herein (e.g., with at least one reactive group, as described herein, such as 1, 2, 3, or 4 reactive groups).

Examples of suitable bidentate ligands include, for example, 1,10-phenanthroline, an amino acid, oxalic acid, acetylacetone, a diaminoalkane, an ortho-diaminoarene, 2,2′-biimidazole, 2,2′-bioxazole, 2,2′-bithiazole, 2-(2-pyridyl) imidazole, 2,2′-bipyrazine, 1,10-phenanthroline, 2-phenylpyridine, and 2,2′-bipyridine, each of which can be unsubstituted or substituted, as described herein (e.g., substituted with at least one reactive group, such as 1, 2, 3, or 4 reactive groups). Examples of suitable tridentate ligands include, for example, diethylenetriamine, 2,2′,2″-terpyridine, 2,6-bis(N-pyrazolyl)pyridine, and N,N,N′,N″,N″-pentamethyldiethylenetriamine (PMDETA), each of which can substituted or unsubstituted (e.g., substituted with one more alkyl groups, such as methyl, or one or more reactive groups). Examples of suitable tetradentate ligands include, for example, tris(2-aminoethyl)amine (TREN), tris[2-(dimethylamino)ethyl]amine (Me₆TREN), tris(2-pyridylmethyl)amine (TPMA), tris([(4-methoxy-2,5-dimethyl)-2-pyridyl] methyl)amine (TPMA*), tetraazaannulene, a phthalocyanine, and a porphyrin, such as a phenylporphyrin (e.g., tetraphenylporphyrin, tetra (pentafluorophenyl) porphyrin, 5-(4-carboxyphenyl)-10,15,20-triphenylporphyrin, tetramethoxyphenylporphyrin, tetra-(p-aminophenyl)porphyrin, 5,10,15,20-tetrakis(4-t-butylphenyl)porphyrin, 5,10,15-triaryl-20-phenylporphyrin, 5,10,15,20-tetrakis(o-2-mercaptoethoxyphenyl)porphyrin), each of which can be unsubstituted or substituted, as described herein (e.g., substituted with at least one reactive group, as described herein, such as, 1, 2, 3, or 4 reactive groups).

In some aspects, the photoredox catalyst can comprise at least one ligand selected from 2,2′-bipyridine (bpy), 4,4′-dimethyl-2,2′-dipyridine, 4,4′-di-tert-butyl-2,2′-dipyridine, 4,4′-diethylester-2,2′-bipyridine, 2-phenylpyridine (ppy), 2-(2,4-difluorophenyl)-5-(trifluoromethyl)pyridine (dF(CF₃)ppy), 2-(2,4-difluorophenyl) pyridine, 4-(tert-butyl)-2-[4-(tert-butyl)phenyl]pyridine (dtbbpy), 4-methyl-2-(4-methylphenyl)pyridine, bis(pyrazolyl)methane, 2,2′-bipyrazine (bpz), 1,10-phenanthroline (phen), 4,7-dichloro-1,10-phenanthroline, 4,7-dimethoxy-1,10-phenanthroline, 7,8-benzoquinoline, a phenylporphyrin, and any combination thereof.

In some aspects, the photoredox catalyst can include a counterion (X) to balance the charge of the transition metal as needed. Typically, there will be 1 to 5 (i.e., 1, 2, 3, 4, or 5) counterions. Multiple counterions to balance a charge are not necessarily all the same. Examples of suitable counterions include anions, such as halide (e.g., fluoride, chloride, bromide, or iodide), hydroxy, nitrate, perchlorate, sulfate, sulfite, phosphate, mesylate, triflate, acetate, trifluoroacetate, hexafluorophosphate, tetraphenylborate, tetrakis(pentafluorophenyl)borate, and tetrafluoroborate, and cations (e.g., a monovalent cation), such as lithium, sodium, potassium, and a quaternary ammonium (e.g., tetralkylammonium, ammonium). In some aspects, the counterion can be a halide, such as chloride.

In some aspects, the photoredox catalyst can comprise Ru(bpy)₃²⁺, Ru(bpz)₃²⁺, Ir(ppy)₃, Ir(ppy)₂(dtbbpy)⁺, Ir[dF(CF₃)ppy]₂(dtbbpy)⁺, or zinc tetraphenylporphyrin (Zn-TPP).

The photoredox catalyst can be used in any suitable amount that drives the polymerization reaction. In some aspects, the photoredox catalyst can be used in a parts per million (ppm) concentration relative to the components of the polymeric brush structure (e.g., first polymeric brush structure, second polymeric brush structure). In some aspects, the photoredox catalyst can be used in about 10 ppm to about 200 ppm. The amount can be, for example, about 10 ppm or more (e.g., about 20 ppm or more, about 30 ppm or more, about 40 ppm or more, about 50 ppm or more, about 60 ppm or more, about 70 ppm or more, about 80 ppm or more, about 90 ppm or more, about 100 ppm or more, about 110 ppm or more, about 120 ppm or more, about 130 ppm or more, about 140 ppm or more, about 150 ppm or more, about 160 ppm or more, about 170 ppm or more, about 180 ppm or more, or about 190 ppm or more) to about 200 ppm or less. The amount can be, for example, about 200 ppm or less (e.g. about 190 ppm or less, about 180 ppm or less, about 170 ppm or less, about 160 ppm or less, about 150 ppm or less, about 140 ppm or less, about 130 ppm or less, about 120 ppm or less, about 110 ppm or less, about 100 ppm or less, about 90 ppm or less, about 80 ppm or less, about 70 ppm or less, about 60 ppm or less, about 50 ppm or less, about 40 ppm or less, about 30 ppm or less, or about 20 ppm or less) to about 10 ppm or more. In some aspects, the photoredox catalyst can be used in about 20 ppm to about 100 ppm, about 30 ppm to about 80 ppm, or about 40 ppm to about 60 ppm.

In some aspects, the polymeric brush structure (e.g., first polymeric brush structure, second polymeric brush structure) can be formed by reacting (i) at least one vinyl-containing group comprising a pre-glass precursor with (ii) a polymerization active group on the linker comprising a reversible addition-fragmentation chain-transfer (RAFT) agent or an atom transfer radical polymerization (ATRP) initiator.

In some aspects, the polymerization active group can be an alkoxyamine initiator when the polymerization is a nitroxide-mediated radical polymerization. Typically, the alkoxyamine can comprise a cyclic or acyclic nitroixde. Examples of suitable alkoxyamine initiators include, e.g., TEMPO-based alkoxyamine, TIPNO-based alkoxyamine, and SG1-based alkoxyamine, in which the oxygen in the nitroxide group is attached to an optionally substituted alkyl group (e.g., ethylbenzene, 2-methylpropanic acid). TEMPO is 2,2,6,6-tetramethyl-1-piperidinyloxy; TIPNO is 2,2,5-trimethyl-4-phenyl-3-azahexane-3-nitroxide; and SG1 is N-1-diethylphosphono-2-dimethyl-N-1-dimethylethyl N-oxyl. The alkoxy group can be any suitable —O-alkyl group, as described herein, but typically is a C₁₋₆ alkoxy. In some aspects, the alkoxy can include other substituents, such as phenyl, hydroxy, carboxy (—C(O)OH), alkoxycarbonyl (—C(O)Oalkyl), amido, halo, cyano, or any combination thereof. Examples of suitable alkoxyamines are described in, for example, EP 1083169A1, the entire disclosure of which is incorporated by reference herein.

The at least one vinyl-containing group can be any vinyl group that can be polymerized using a method described herein. In some aspects, the at least one vinyl-containing group can be styrene, acrylate, methacrylate, acrylamide, methacrylamide, vinyl ester, vinyl amide, or any combination thereof, each of which can be unsubstituted or substituted, as described herein. For example, the vinyl-containing group can be modified to have an alkylenyl chain of the formula —(CH₂)ₘ—, in which m is an integer from 1 to 10 (i.e., 1, 2, 3, 4, 5, 6, 7, 8, 9, or 10) that can be optionally functionalized with a reactive group, as described herein, for attachment to the pre-glass precursor, as described herein. In some aspects, the vinyl-containing group can be methacrylate optionally comprising an alkylenyl chain (e.g., —(CH₂)ₘ—, in which m is an integer from 1 to 10, 1 to 6, 1 to 5, 1 to 4, 1 to 3, or 1 to 2).

In some aspects, the pre-glass precursor can be attached (e.g., terminally attached) to the at least one vinyl group optionally through an alkylenyl group. If necessary, either the vinyl group, the alkylenyl group, and/or the pre-glass precursor can be modified to provide a reactive group to enable the coupling of the at least one vinyl group and the pre-glass precursor. Suitable reactive groups and coupling reactions are described herein.

In some aspects, the pre-glass precursor can be silicon-based, titanium-based, zirconium-based, aluminum-based, cerium-based, or any combination thereof. In some aspects, the pre-glass precursor can comprise SiOx (e.g., silicon dioxide, silicon monoxide), TiOx (e.g., titanium dioxide), ZrOx (zirconium oxide, including stabilized forms of zirconia, e.g., zirconia toughened alumina, partially stabilized zirconia, fully stabilized zirconia, tetragonal zirconia polycrystal, transformed toughened zirconia, ceria stabilized zirconia), or any combination thereof.

In some aspects, the pre-glass precursor can comprise a silsesquioxane, which can be unsubstituted or substituted and can be random, ladder-like, or cage-like, which includes partial cage-like. In some aspects, the pre-glass precursor can comprise an unsubstituted cage-like silsesquioxane. In some aspects, the silsesquioxane can be characterized by the general formula RₐSiₐO_{(1.5a-0.5b)}(OH)_{b}, where R is a hydrogen atom or an organic group (e.g., alkyl, aryl, alkenyl (e.g., a vinyl-containing group), alkoxy, alkylenyl, arylenyl, or cycloalkyl, each of which can be unsubstituted or substituted) and a and b are integer numbers (a=1, 2, 3 . . . ; b=0, 1, 2, 3 . . . ), with a+b=2n, where n is an integer (n=1, 2, 3 . . . ), and b≤a+2. The silsesquioxane can be described by the values of a and b in the general formula, such as a7b3, which refers to a silsesquioxane containing seven Si atoms and three single bond OH groups. Other silsesquioxanes include, e.g., a1b3, a2b4, a3b3, a4b4, a6b2, a6b4, a6b6, a7b1, a7b3, a8b2 (form I), a8b2 (form II), a8b4 (form I), a8b4 (form II), a6b0, a8b0, a10b0, and a12b0. Examples of a silsesquioxane include, e.g., polyoctahedral silsesquioxane (POSS; a8b0), hydrogen silsesquioxane, disilanol POSS, and trisilanol POSS.

In some aspects, the pre-glass polymerizable precursor can be a polyoctahedral silsesquioxane (POSS) comprising at least one vinyl-containing group. In some aspects, the pre-glass polymerizable precursor can be POSS comprising one vinyl-containing group. In some aspects, the pre-glass polymerizable precursor can be POSS comprising one vinyl-containing group, such formula (I):

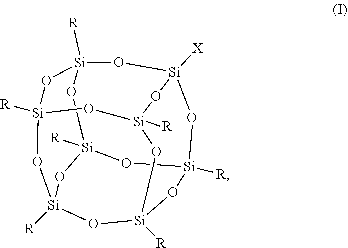

in which R can be H, alkyl, aryl, alkenyl, alkoxy, alkylenyl, arylenyl, or cycloalkyl; and X can be a vinyl-containing group (e.g., styrene, acrylate, methacrylate, acrylamide, methacrylamide, vinyl ester, vinyl amide, or any combination thereof). In some aspects, any R in formula (I) can be replaced with an X, such that formula (I) can contain more than one vinyl-containing group. In some aspects, the pre-glass polymerizable precursor can be POSS comprising one methacrylate group, e.g., X can be —(CH₂)₃OC(O)C(CH₃)═CH₂ (methacrylyoyl) or —(CH₂)₃OC(O)CH═CH₂ (acryloyl). In some aspects of formula (I), one or more Si atoms can be replaced with an atom selected from Al, Ti, Zr, Ce, and combinations thereof.

To form the polymeric brush structure (e.g., first polymeric brush structure, second polymeric brush structure) the at least one vinyl-containing group comprising a pre-glass precursor can be reacted with a polymerization active group that can be a reversible RAFT agent or ATRP initiator.

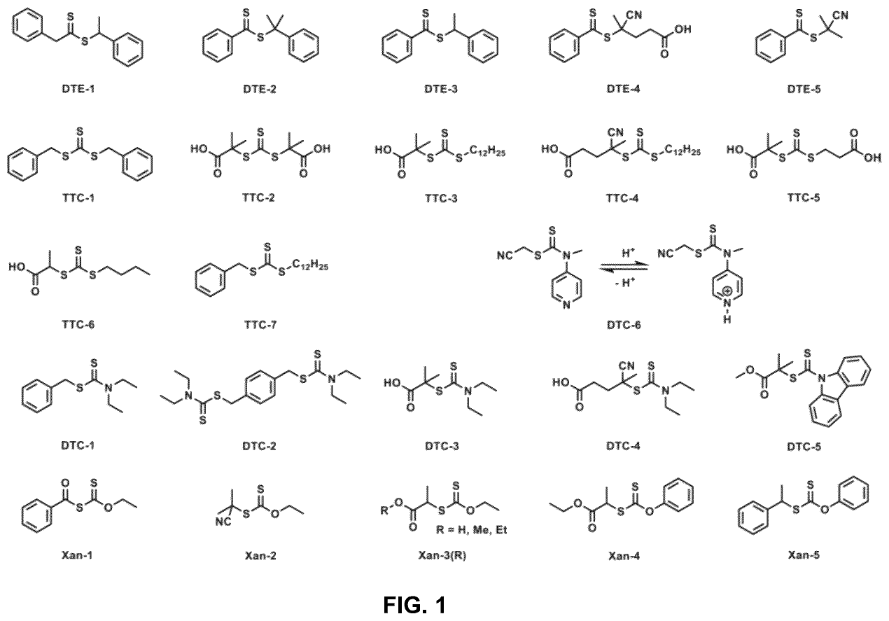

In some aspects, the polymerization active group can be a RAFT agent. In some aspects, the RAFT agent can comprise a dithioester, a dithiocarbamate, a trithiocarbonate moiety, or a xanthate (e.g., a dithiocarbonate). For example, a RAFT agent can be one of the following:

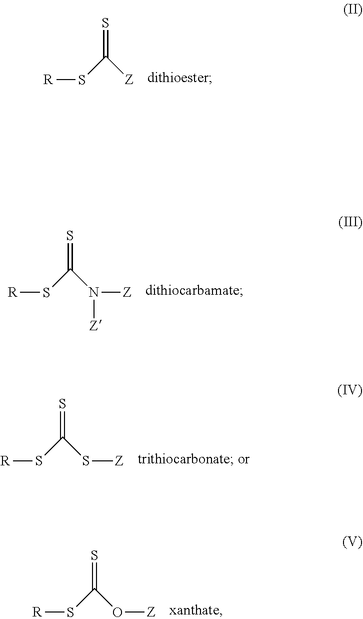

wherein R in each of formulas (II)-(V) can be phenyl or alkyl that is optionally substituted with phenyl, cyano, carboxy, amino or alkylcarboxy; and Z can be alkyl, carboxyalkyl, phenyl, phenylalkyl, thioalkyl (—S-alkyl), alkoxy, phenoxy, dialkylamino, aryl(alkyl)amino, pyrrolyl, or 1-pyrrolidin-2-one. Exemplary RAFT agents are set forth in FIG. 1.

In some aspects, the R or Z group of the RAFT agent can be coupled to the linker, such as through a reactive group on the linker. In some aspects, the R group of the RAFT agent can be coupled to the linker through a reactive group on the linker. In an example, when a dithioester of formula (I) is used as the RAFT agent, the polymerized vinyl group can be inserted between the R group and sulfur in the R—S bond of the RAFT agent to retain the RAFT functionality for further chemical modification, as desired.

In some aspects, the polymerization active group can be an ATRP initiator. In some aspects, the ATRP initiator can comprise a halide selected from chloride, bromide, or iodide. In some aspects, the ATRP initiator can be a residue of 2-bromopropanitrile (BPN), 2-chloropropanitrile (CIPN), 2-bromoacetonitrile (BrAN), 2-chloroacetonitrile (CIAN), ethyl 2-bromoisobutyrate (BriB), ethyl 2-bromopropionate (EBrP), methyl 2-bromopropionate (MBrP), 1-phenyl ethylbromide (1-PEBr), tosyl chloride (TsCl), 1-cyano-1-methylethyldiethyldithiocarbamte (MANDC), 2-(N,N-diethyldithiocarbamyl)-isobutyric acid ethyl ester (EMADC), dimethyl 2,6-dibromoheptanedioate (DMDBHD), benzyl chloride (BzCl), benzyl bromide (BzBr), 1-chloro-1-phenylethane (PECl), 1-bromo-1-phenylethane (PEBr), methyl 2-chloro-2-methylpropanoate, methyl 2-bromo-2-methylpropanoate, ethyl 2-chloro-2-methylpropanoate, ethyl 2-bromo-2-methylpropanoate, allyl chloride, allyl bromide, ethyl 2-bromo-2-phenylacetate (EBPA), ethyl 2-bromo-2-phenylacetate (ECPA), ethyl 2-chloro-2-phenylacetate, methyl 2-iodopropanoate (MIP), tert-butyl 2-bromopropanoate (tBBrP), methyl 2-bromoacetate (MBrAc), methyl 2-chloroacetate (MClAc), methyl-2-bromopropanoate (MBrP), 1-bromo-4-(1-bromoethyl)benzene, (1-bromoethyl)benzene, vinyl-2-chloroacetate, diethyl 2-bromo-2-methylmalonate (DBMM), 3-hydroxypropyl 2-bromo-2-methylpropanoate (HPBIB), or 3-bromodihydrofuran-2(3H)-one. In some aspects, the ATRP initiator can be a residue of ethyl 2-bromoisobutyrate (BriB).

In some aspects, the ATRP initiator (e.g., a residue as described above) can be coupled to a linker, such as through a reactive group on the linker. In some aspects, the ATRP initiator can be coupled to the linker through a terminal reactive group on the linker. In an example, when a BriB is used as the ATRP initiator, the polymerized vinyl group can be inserted between the bromo and isobutyrate on the ATRP initiator to retain the ATRP functionality for further chemical modification, as desired.

In some aspects, the polymerization can be light activated when a photoredox catalyst is used. In some aspects, the light can be ultraviolet (UV) light, visible light, or near infrared (IR) light. In some aspects, low light intensity and long wavelength UV irradiation can be used to promote polymerization. In some aspects, light with a wavelength of about 405nm, about 450 to about 530 nm, or about 560 to about 635 nm can be used, depending on the polymerization active agent and/or photoredox catalyst. In some aspects, a visible light-emitting diode (LED) light can be used. In some aspects, the light intensity can be about 1 W to about 4.8 W power.

The polymerization can be performed at any suitable temperature. In some aspects, the polymerization can be performed at room temperature (e.g., about 25° C.).

The polymerization can be performed for any suitable length of time. The time can be adjusted to modify one or more dimensions (e.g., thickness) of the nanostructure(s). In an aspect, when a RAFT agent or ATRP initiator is used as a polymerization active agent, the living nature of PET-RAFT and PET-ATRP can provide a predictable film thickness based on the time of the polymerization reaction. In some aspects, the polymerization can be run for about 5 min or more to about 10 hours or less. For example the polymerization can be run for about 10 min or more (e.g., about 15 min or more, about 30 min or more, about 45 min or more, about 1 hr or more, about 1.5 hr or more, about 2 hr or more, about 2.5 hr or more, about 3 hr or more, about 3.5 hr or more, about 4 hr or more, about 4.5 hr or more, about 5 hr or more, about 5.5 hr or more, about 6 hr or more, about 6.5 hr or more, about 7 hr or more, about 7.5 hr or more, about 8 hr or more, about 8.5 hr or more, about 9 hr or more, about 9.5 hr or more) to about 10 hours or less (e.g., about 9.5 hr or less, about 9 hr or less, about 8.5 hr or less, about 8 hr or less, about 7.5 hr or less, about 7 hr or less, about 6.5 hr or less, about 6 hr or less, about 5.5 hr or less, about 5 hr or less, about 4.5 hr or less, about 4 hr or less, about 3.5 hr or less, about 3 hr or less, about 2.5 hr or less, about 2 hr or less, about 1.5 hr or less, or about 1 hr or less). In some aspects, the polymerization can be run for about 1 to 10 hr, about 1 to 8 hr, about 1 to 6 hr, about 2 to 6 hr, or about 2 to 5 hr.

The polymerization can be performed in any suitable atmosphere, including in the presence of oxygen or in an inert atmosphere (e.g., nitrogen, argon, etc.).

In some aspects, a photomask can be used on the substrate to provide a particular desired pattern. A controlled pattern can be provided by selectively masking over areas that will not include the desired nanostructure or can include a different (e.g., second) nanostructure. In some aspects a photomask can be used when patterning the substrate. In other aspects, a photomask will not be used when patterning the substrate.

In some aspects, a neutral density (ND) filter can be used on the substrate to control the amount of light. In some aspects an ND filter can be used when patterning the substrate. In other aspects, an ND filter will not be used when patterning the substrate. In some aspects, both an ND filter and a photomask can be used when patterning the substrate.

Once the polymeric brush structures are attached to the at least one surface of a substrate, the method requires curing a polymeric brush structure (e.g., first polymeric brush structure, second polymeric brush structure) to form a nanostructure comprising glass. Not wishing to be bound by theory, it is believed that during the curing step, the organics are substantially burned away and the pre-glass precursor is converted to a glass nanostructure. In some aspects, there is a residual amount of organic remaining after the curing step that is detectable by one or more methods known in the art, including time-of-flight ion mass spectrometry (ToF-SIMS) and/or x-ray photoelectron spectroscopy (XPS). In some aspects, the curing can comprise using heat, reactive plasma, or both heat and reactive plasma. In some aspects, the curing can be effected by exposure to heat, e.g., pyrolysis, convection oven, hot plate, infrared (IR) irradiation, or a combined thermal and UV cure process.

In some aspects, plasma curing (e.g., UV plasma curing) can be used. Typically, plasma curing can include placing the coated substrate in a closed chamber filled with a specific gas, followed by microwave excitation or ignition of the gas to inducing a plasma. The plasma can be any suitable medium, such as reactive oxygen, reactive oxygen species, reactive nitrogen species, or a noble gas (e.g., helium or argon), or a mixture thereof (e.g., nitrogen and helium). In some aspects, the curing can be an oxygen plasma treatment.

The temperature used for curing can be any suitable temperature that allows the pre-glass precursor to form a glass. In some aspects, the curing temperature is at least about 300° C. and generally does not exceed about 1600° C. (e.g., does not exceed about 1400° C., does not exceed about 1200° C., does not exceed about 1000° C., does not exceed about 800° C., does not exceed about 600° C., or does not exceed about 550° C.). In some aspects, the curing temperature is about 300° C. to about 1200° C., about 400° C. to about 1000° C., about 500° C. to about 800° C., or about 500° C. to about 600° C. In some aspects, the curing temperature is about 550° C.

The curing time can be any time suitable to allow the pre-glass precursor to form a glass. In some aspects, the curing time can be about 1 min to about 5 hours (e.g., about 2 min to about 5 hr, about 5 min to about 4 hr, about 10 min to about 4 hr, about 20 min to about 3 hr, or about 1 min to about 1 h).

The curing step reduces the carbon content in the nanostructures relative to the nanostructures prior to curing. In some aspects, the nanostructure after curing can be substantially free of carbon. In some aspects, the nanostructure after curing can comprise a detectable amount of carbon, such as about 20 atomic % or less down to the limit of detection of carbon. In some aspects, the nanostructure after curing comprises about 19 atomic % or less (e.g., about 18 atomic % or less, about 17 atomic % or less, about 16 atomic % or less, about 15 atomic % or less, about 14 atomic % or less, about 13 atomic % or less, about 12 atomic % or less, about 11 atomic % or less, about 10 atomic % or less, about 9 atomic % or less, about 8 atomic % or less, about 7 atomic % or less, about 6 atomic % or less, about 5 atomic % or less, about 4 atomic % or less, about 3 atomic % or less, about 2 atomic % or less, or about 1 atomic % or less) down to the limit of detection of carbon. The carbon level can be measured by any suitable method, including x-ray photoelectron spectroscopy (XPS).

In some aspects, the method can comprise one or more steps in addition to the steps of providing a first polymeric brush structure attached to at least one surface of a substrate; and curing the first polymeric brush structure to form a nanostructure comprising glass. For example, in some aspects, the method can further comprise forming the first polymeric brush structure by contacting (i) at least one vinyl-containing group comprising a pre-glass precursor with (ii) a polymerization active group comprising a reversible addition-fragmentation chain-transfer (RAFT) agent or an atom transfer radical polymerization (ATRP) initiator, in the presence of a redox catalyst. In some aspects, the method can further comprise attaching a polymerization active group to a linker. In some aspects, the method can further comprise attaching a linker to the at least one surface of the substrate by reacting a surface anchoring group attached to the linker with at least one reactive group on the at least one surface.

In some aspects, the method can comprise:
forming a first polymeric brush structure comprising a pre-glass polymerizable precursor by contacting (i) at least one vinyl-containing group comprising a pre-glass precursor with (ii) a polymerization active group comprising a reversible addition-fragmentation chain-transfer (RAFT) agent or an atom transfer radical polymerization (ATRP) initiator, in the presence of a redox catalyst;
attaching the first polymeric brush structure to at least one surface of a substrate; and
curing the first polymeric brush structure to form a nanostructure comprising glass.

In some aspects, the method can comprise:
forming a first polymeric brush structure comprising a pre-glass polymerizable precursor by contacting (i) at least one vinyl-containing group comprising a pre-glass precursor with (ii) a polymerization active group comprising a reversible addition-fragmentation chain-transfer (RAFT) agent or an atom transfer radical polymerization (ATRP) initiator, in the presence of a redox catalyst;
attaching the polymerization active group to a linker;
attaching the first polymeric brush structure to at least one surface of a substrate; and
curing the first polymeric brush structure to form a nanostructure comprising glass.

In some aspects, the method can comprise:
forming a first polymeric brush structure comprising a pre-glass polymerizable precursor by contacting (i) at least one vinyl-containing group comprising a pre-glass precursor with (ii) a polymerization active group comprising a reversible addition—fragmentation chain-transfer (RAFT) agent or an atom transfer radical polymerization (ATRP) initiator, in the presence of a redox catalyst;
attaching the polymerization active group to a linker;
attaching the first polymeric brush structure to at least one surface of a substrate by reacting a surface anchoring group attached to the linker with at least one reactive group on the at least one surface; and
curing the first polymeric brush structure to form a nanostructure comprising glass.

In some aspects, the method can provide a substrate comprising more than one type (e.g., a different size and/or shape) nanostructure. Thus, the method can comprise:
providing a first polymeric brush structure attached to at least one surface of a substrate, wherein the first polymeric brush structure comprises a pre-glass polymerizable precursor;
providing a second polymeric brush structure, wherein the first polymeric brush structure is different from the second polymeric brush structure; and
curing both the first polymeric brush structure and the second polymeric brush structure.

The second polymeric brush structure and the method of forming the second polymeric brush structure are as described herein with respect to the first polymeric brush structure. In some aspects of this method, a mask (e.g., a photomask) can be used to provide the desired pattern of first and second nanostructures. These steps can be repeated to provide any number of different (e.g., 2, 3, 4, etc.) types of nanostructures on the substrate prior to curing.

Once the nanostructure comprising glass has been prepared, the surface can be further modified, if desired. For example, in some aspects, the method can comprise coating the nanostructure and substrate with a silane to provide an antiwetting (e.g., an easy to clean) surface. The silane can be any suitable silane but typically will be a hydrophobic/oleophobic silane. Examples of a suitable silane include, e.g., a fluoropolyether silane comprising hydrolysable groups. In some aspects, the silane can be combined with one or more solvents (e.g., an organic solvent), such as an alcohol (e.g., C₁₋₄ alcohol), an ether alcohol, ethylene glycol, a ketones, an ester (e.g., ethyl acetate), methylformate, an ether (e.g., partially or completely fluorinated ethers), partially or completely fluorinated hydrocarbons, and mixtures thereof. In some aspects, once the silane or silane solution has been deposited on the glass nanostructure surface, excess solvent can be removed if needed, and the silane coating can be cured. Curing the silane coating can be at any suitable temperature (e.g., about 300° C. or less, about 200° C. or less, about 150° C. or less, about 100° C. or less, or about 80° C. or less).

### Nanostructured Substrates of the Disclosure

The present disclosure also relates to a substrate, comprising:
a surface comprising a plurality of nanostructures comprising glass,
wherein at least a portion of the nanostructures comprises a detectable amount of carbon by x-ray photoelectron spectroscopy (XPS).

The substrate is as described herein.

In some aspects, the detectable amount of carbon (e.g., carbon percent) by XPS can be less than 20 atomic % down to the limit of detection of carbon. In some aspects, at least a portion of the nanostructure can comprise about 19 atomic or less (e.g., about 18 atomic % or less, about 17 atomic % or less, about 16 atomic % or less, about 15 atomic % or less, about 14 atomic % or less, about 13 atomic % or less, about 12 atomic % or less, about 11 atomic % or less, about 10 atomic % or less, about 9 atomic % or less, about 8 atomic % or less, about 7 atomic % or less, about 6 atomic % or less, about 5 atomic % or less, about 4 atomic % or less, about 3 atomic % or less, about 2 atomic % or less, or about 1 atomic % or less) down to the limit of detection of carbon.

The size and shape of the nanostructures can be controlled using, for example, time, light intensity, and/or a mask (e.g., a photomask). In some aspects, at least a portion of the plurality of nanostructures can have an average diameter of about 1 nm to about 10 μm. For example, at least a portion (including all) of the plurality of nanostructures can have an average diameter of about 1 nm or more (e.g., about 2 nm or more, about 3 nm or more, about 4 nm or more, about 5 nm or more, about 10 nm or more, about 20 nm or more, about 30 nm or more, about 40 nm or more, about 50 nm or more, about 60 nm or more, about 70 nm or more, about 80 nm or more, about 90 nm or more, about 100 nm or more, about 200 nm or more, about 400 nm or more, about 600 nm or more, about 800 nm or more, about 800 or more, about 1 μm or more, about 2 μm or more, about 3 μm or more, about 4 μm or more, about 5 μm or more, about 6 μm or more, about 7 μm or more, about 8 μm or more, or about 9 μm or more) to about 10 μm or less (e.g., about 9 μm or less, about 8 μm or less, about 7 μm or less, about 6 μm or less, about 5 μm or less, about 4 μm or less, about 3 μm or less, about 2 μm or less, about 1 μm or less, about 800 nm or less, about 600 nm or less, about 400 nm or less, about 200 nm or less, about 100 nm or less, about 90 nm or less, about 80 nm or less, about 70 nm or less, about 60 nm or less, about 50 nm or less, about 40 nm or less, about 30 nm or less, about 20 nm or less, about 10 nm or less, about 9 nm or less, about 8 nm or less, about 7 nm or less, about 6 nm or less, about 5 nm or less, about 4 nm or less, about 3 nm or less, or about 2 nm or less). In some aspects, the plurality of nanostructures can have an average diameter of about 10 nm to about 10 μm, about 50 nm to about 10 μm, about 100 nm to about 10 μm, about 200 nm to about 10 μm, about 500 nm to about 10 μm, about 1 μm to about 10 μm, about 2 μm to about 10 μm, or about 5 μm to about 10 μm.

In some aspects, at least a portion of the plurality of nanostructures can have an average height (e.g., thickness) of about 1 nm to about 300 nm. For example, at least a portion (including all) of the plurality of nanostructures can have an average height (e.g., thickness) of about 1 nm or more (e.g., about 2 nm or more, about 3 nm or more, about 4 nm or more, about 5 nm or more, about 10 nm or more, about 20 nm or more, about 30 nm or more, about 40 nm or more, about 50 nm or more, about 60 nm or more, about 70 nm or more, about 80 nm or more, about 90 nm or more, about 100 nm or more, or about 200 nm or more) to about 300 nm or less (e.g., about 200 nm or less, about 100 nm or less, about 90 nm or less, about 80 nm or less, about 70 nm or less, about 60 nm or less, about 50 nm or less, about 40 nm or less, about 30 nm or less, about 20 nm or less, about 10 nm or less, about 9 nm or less, about 8 nm or less, about 7 nm or less, about 6 nm or less, about 5 nm or less, about 4 nm or less, about 3 nm or less, or about 2 nm or less). In some aspects, at least a portion (including all) of the plurality of nanostructures can have an average height (e.g., thickness) of about 10 nm to about 200 nm, about 10 nm to about 100 nm or about 10 nm to about 50 nm.

Various aspects are contemplated herein, several of which are set forth in the paragraphs below. It is explicitly contemplated that any aspect or portion thereof can be combined with any other aspect or portion thereof to form a system, method or composition in accordance with present disclosure.
Aspect (1) A method of forming a nanostructure, comprising: providing a first polymeric brush structure attached to at least one surface of a substrate, wherein the first polymeric brush structure comprises a pre-glass polymerizable precursor; and curing the first polymeric brush structure to form a nanostructure comprising glass.
Aspect (2) The method of aspect (1), wherein the first polymeric brush structure is attached to the at least one surface of the substrate through a surface anchoring group on the first polymeric brush structure.
Aspect (3) The method of aspect (2), or any preceding aspect, wherein prior to attachment, the surface anchoring group is a silyl, hydroxy, thiol, alkenyl, alkynyl, alkoxy, carboxy, hydroxamic acid, amino, azido, halide, phosphono, or sulfonato.
Aspect (4) The method of aspect (3), or any preceding aspect, wherein prior to attachment, the surface anchoring group is a silyl of the formula SiRₓA_{y}B, where R is a non-reactive group, A is a group that can react with the surface of the substrate, B is a pendant group capable of participating in a coupling reaction, x is an integer of 0, 1, or 2, y is an integer of 1, 2, or 3, wherein x+y=3.
Aspect (5) The method of any one of aspects (1)-(4), wherein the substrate comprises at least one reactive group on the at least one surface and comprises a glass, a metal oxide, a metal, carbon, silicon, a polymer, or any combination thereof.
Aspect (6) The method of any one of aspects (2)-(5), or any preceding aspect, wherein the pre-glass polymerizable precursor is connected to the surface anchoring group by a linker.
Aspect (7) The method of aspect (6), or any preceding aspect, wherein the linker comprises an alkyl chain optionally substituted with one or more of NH, O, S, C(O), or any combination thereof.
Aspect (8) The method of aspect (7), or any preceding aspect, wherein the linker is a C₁-C₁₀ alkyl chain.
Aspect (9) The method of any one of aspects (6)-(8), or any preceding aspect, wherein the first polymeric brush structure is formed by a photoelectron transfer polymerization process comprising a photoredox catalyst.
Aspect (10) The method of aspect (9), or any preceding aspect, wherein the first polymeric brush structure is formed by reacting (i) at least one vinyl-containing group comprising a pre-glass precursor with (ii) a polymerization active group on the linker comprising a reversible addition-fragmentation chain-transfer (RAFT) agent or an atom transfer radical polymerization (ATRP) initiator.
Aspect (11) The method of aspect (10), or any preceding aspect, wherein the RAFT agent comprises a dithioester, a dithiocarbamate, a trithiocarbonate moiety, or a xanthate.
Aspect (12) The method of aspect (10), or any preceding aspect, wherein the ATRP initiator comprises a halide selected from chloride, bromide, or iodide.
Aspect (13) The method of aspect (12), or any preceding aspect, wherein the ATRP initiator is a residue of 2-bromopropanitrile (BPN), 2-chloropropanitrile (CIPN), 2-bromoacetonitrile (BrAN), 2-chloroacetonitrile (CIAN), ethyl 2-bromoisobutyrate (BriB), ethyl 2-bromopropionate (EBrP), methyl 2-bromopropionate (MBrP), 1-phenyl ethylbromide (1-PEBr), tosyl chloride (TsCl), 1-cyano-1-methylethyldiethyldithiocarbamte (MANDC), 2-(N,N-diethyldithiocarbamyl)-isobutyric acid ethyl ester (EMADC), dimethyl 2,6-dibromoheptanedioate (DMDBHD), benzyl chloride (BzCl), benzyl bromide (BzBr), 1-chloro-1-phenylethane (PECl), 1-bromo-1-phenylethane (PEBr), methyl 2-chloro-2-methylpropanoate, methyl 2-bromo-2-methylpropanoate, ethyl 2-chloro-2-methylpropanoate, ethyl 2-bromo-2-methylpropanoate, allyl chloride, allyl bromide, ethyl 2-bromo-2-phenylacetate (EBPA), ethyl 2-bromo-2-phenylacetate (ECPA), ethyl 2-chloro-2-phenylacetate, methyl 2-iodopropanoate (MIP), tert-butyl 2-bromopropanoate (tBBrP), methyl 2-bromoacetate (MBrAc), methyl 2-chloroacetate (MClAc), methyl-2-bromopropanoate (MBrP), 1-bromo-4-(1-bromoethyl)benzene, (1-bromoethyl)benzene, vinyl-2-chloroacetate, diethyl 2-bromo-2-methylmalonate (DBMM), 3-hydroxypropyl 2-bromo-2-methylpropanoate (HPBIB), or 3-bromodihydrofuran-2(3H)-one.
Aspect (14) The method of any one of aspects (10)-(13), or any preceding aspect, wherein the at least one vinyl-containing group is styrene, acrylate, methacrylate, acrylamide, methacrylamide, vinyl ester, vinyl amide, or any combination thereof.
Aspect (15) The method of aspect (14), or any preceding aspect, wherein the vinyl-containing group is methacrylate.
Aspect (16) The method of any one of aspects (10)-(15), or any preceding aspect, wherein the pre-glass precursor is silicon-based, titanium-based, zirconium-based, aluminum-based, cerium-based, or any combination thereof.
Aspect (17) The method of any one of aspects (10)-(16), or any preceding aspect, wherein the pre-glass precursor comprises SiOx, TiOx, ZrOx, or any combination thereof.
Aspect (18) The method of aspect (17), wherein the pre-glass precursor comprises a silsesquioxane.
Aspect (19) The method of any one of aspects (1)-(18), wherein the pre-glass polymerizable precursor is a polyoctahedral silsesquioxane (POSS) comprising at least one vinyl-containing group.
Aspect (20) The method of any one of aspects (9)-(19), or any preceding aspect, wherein the photoredox catalyst comprises ruthenium, copper, iridium, or zinc.
Aspect (21) The method of aspect (20), wherein the photoredox catalyst comprises at least one ligand selected from 2,2′-bipyridine (bpy), 4,4′-dimethyl-2,2′-dipyridine, 4,4′-di-tert-butyl-2,2′-dipyridine, 4,4′-diethylester-2,2′-bipyridine, 2-phenylpyridine (ppy), 2-(2,4-difluorophenyl)-5-(trifluoromethyl)pyridine (dF(CF₃)ppy), 2-(2,4-difluorophenyl)pyridine, 4-(tert-butyl)-2-[4-(tert-butyl)phenyl]pyridine (dtbbpy), 4-methyl-2-(4-methylphenyl)pyridine, bis(pyrazolyl)methane, 2,2′-bipyrazine (bpz), 1,10-phenanthroline, 4,7-dichloro-1,10-phenanthroline, 4,7-dimethoxy-1,10-phenanthroline, 7,8-benzoquinoline, a phenylporphyrin, and any combination thereof.
Aspect (22) The method of any one of aspects (9)-(21), or any preceding aspect, wherein the photoredox catalyst comprises Ru(bpy)₃²⁺, Ru(bpz)₃²⁺, Ir(ppy)₃, Ir(ppy)₂(dtbbpy)⁺, Ir[dF(CF₃)ppy]₂(dtbbpy)⁺, or zinc tetraphenylporphyrin (Zn-TPP).
Aspect (23) The method of any one of aspects (1)-(22), wherein the curing comprises using heat, reactive plasma, or both heat and reactive plasma.
Aspect (24) The method of any one of aspects (1)-(23), wherein the nanostructure is substantially free of carbon.
Aspect (25) The method of any one of aspects (1)-(24), wherein the nanostructure comprises about 10 atomic % or less of carbon.
Aspect (26) The method of any one of aspects (1)-(25), further comprising forming the first polymeric brush structure by contacting (i) at least one vinyl-containing group comprising a pre-glass precursor with (ii) a polymerization active group comprising a reversible addition-fragmentation chain-transfer (RAFT) agent or an atom transfer radical polymerization (ATRP) initiator, in the presence of a redox catalyst; optionally further comprising attaching the polymerization active group to a linker; and optionally further comprising attaching the linker to the at least one surface of the substrate by reacting a surface anchoring group attached to the linker with at least one reactive group on the at least one surface.
Aspect (27) The method of any one of aspects (1)-(26), further comprising providing a second polymeric brush structure, wherein the first polymeric brush structure is different from the second polymeric brush structure, and then curing both the first polymeric brush structure and the second polymeric brush structure to form nanostructures comprising glass.
Aspect (28) The method of any one of aspects (1)-(27), further comprising coating the nanostructure and substrate with a silane.
Aspect (29) A substrate, comprising: a surface comprising a plurality of nanostructures comprising glass, wherein at least a portion of the nanostructures comprises a detectable amount of carbon by x-ray photoelectron spectroscopy (XPS).
Aspect (30) The substrate of aspect (29), or any preceding aspect, wherein the detectable amount of carbon is less than 20 atomic %.
Aspect (31) The substrate of aspect (29) or (30), or any preceding aspect, wherein the nanostructures have an average diameter of about 1 nm to about 10 μm.
Aspect (32) The substrate of any one of aspects (29)-(31), or any preceding aspect, wherein the nanostructures have an average height of about 1 nm to about 300 nm.
Aspect (33) The substrate of aspect (32), or any preceding aspect, wherein the nanostructures have an average height of about 10 nm to about 200 nm.
Aspect (34) The substrate of any one of aspects (29)-(33), or any preceding aspect, wherein the plurality of nanostructures are formed by the method of any one of aspects (1)-(28).
Aspect (35) A combination of any two or more preceding aspects or any portion thereof.

In some aspects, the plurality of nanostructures can be formed by a method as described herein.

### EXAMPLES

The examples presented below are provided for the purpose of illustration only and the aspects described herein should in no way be construed as being limited to this example. Rather, the aspects should be construed to encompass any and all variations which become evident as a result of the teaching provided herein.

### Example 1

This example describes the formation of a brush initiator in an aspect of the invention. The procedure generally follows the method set forth in Li et al. (ACS Macro Lett, 2019, 8(4): 374-380).

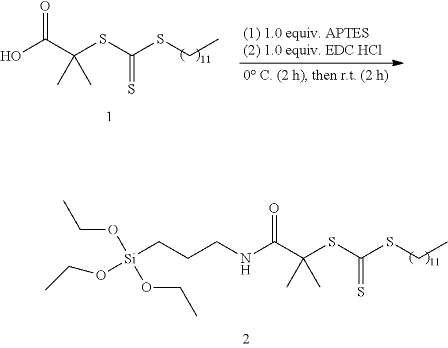

A 250 mL flask equipped with a magnetic stir bar and rubber septum was charged with 2-(dodecylthiocarbonothioylthio)-2-methylpropionic acid (DDMAT) (1, 364.6 mg, 1 mmol) and dichloromethane (DCM) (50 mL). N-(3-dimethylaminopropyl)-N′-ethylcarbodiimide hydrochloride (EDC HCl) (191.7 mg, 1 mmol) dissolved in DCM (10 mL) was then added dropwise into the flask. The solution was then cooled and stirred at 0° C. for 10 min. Sequentially, (3-aminopropyl)triethoxysilane (APTES) (0.23 mL, 1 mmol) was added dropwise into the solution.

The reaction mixture was stirred at 0° C. for 2 hours, then at room temperature for 2 hours, and then concentrated in vacuo. The crude product was purified with silica gel column chromatography (1:1 v/v ethyl acetate and hexanes) to provide the title compound 2 as a viscous yellow liquid.

Compound 2 can be coupled to a reactive group (e.g., —OH) on at least one surface of a substrate.

### Example 2

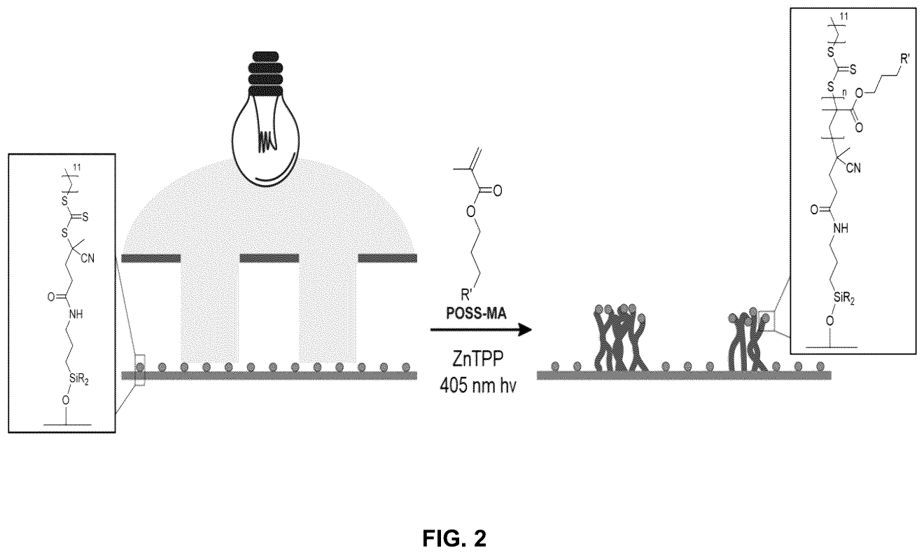

A surface-initiated photoelectron transfer reversible addition-fragmentation chain-transfer (SI-PET-RAFT) polymerization was prepared on a substrate using methacryloisobutyl polyhedral oligomeric silsesquioxanes (POSS-MA), as illustrated in FIG. 2.

### Preparation of RAFT-Functionalized Substrate

Glass slides were cut into 1.5 inch×1.0 inch (3.81 cm×2.54 cm), and placed in piranha solution (H₂SO₄:H₂O₂=3:1 v/v) for 40 min. The glass slides were then thoroughly rinsed with deionized (DI) water and dried in an oven at 110° C. for 10 min. The dried glass slides were then immersed in a solution containing the silane-initiator (25 μL) in 50 mL of dry toluene (0.05 v/v %) for 40 h. Finally, the functionalized glass slides were thoroughly cleaned with toluene followed by isopropanol and dried under the stream of nitrogen gas, and stored in an inert atmosphere.

### SI-PET-RAFT:

To polymerize POSS-MA via surface-initiated photoinduced electron transfer-reversible addition-fragmentation chain transfer polymerization (SI-PET-RAFT), zinc tetraphenylporphyrin (ZnTPP) was used as a photocatalyst (PC). A stock solution containing 1 mg of ZnTPP in 1 mL of toluene was prepared and stored. The monomer was mixed in a 4 mL vial with the PC stock solution with a mole ratio of [POSS-MA]:[CTA]:[PC]=500:1:0.025. The reaction mixture was pipetted on to a RAFT-functionalized glass slide. A cover slip was placed to form a uniform layer of monomer mixture. Finally, the glass slide was irradiated with 405 nm wavelength light for the required amount of time. After the reaction completion, the glass slide was thoroughly washed with toluene followed by isopropanol and dried under a stream of nitrogen.

Spectroscopic characterization techniques were used to validate both the growth of POSS-containing brushes as well as the efficacy of the curing reaction to convert these features into SiOₓ glass features. Profilometry and optical microscopy were used to probe the topography of the patterned films, which were achieved through the use of a striped photomask with a 5 μm pitch as a model system. The final features exemplified were about 10 nm in height. By varying the photomask pattern in combination with the exposure time and/or intensity, 3D control over the silica nanostructures can be afforded.

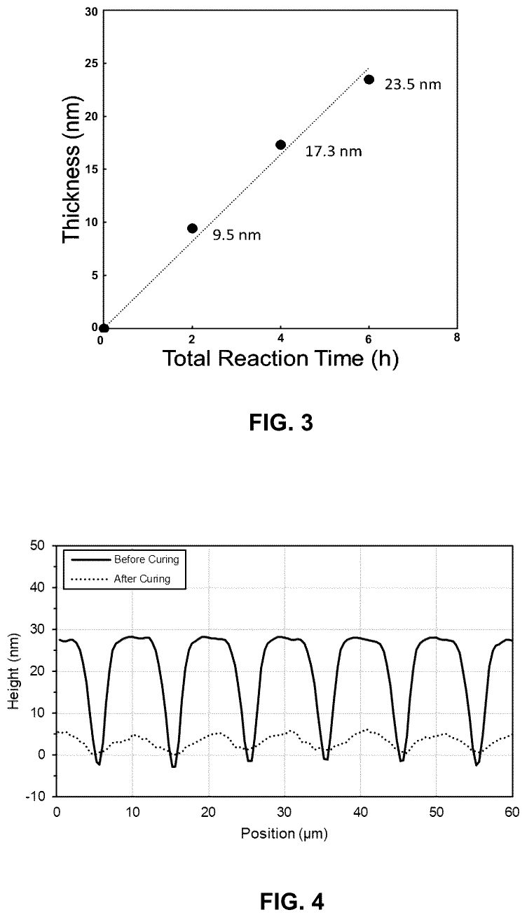

The living nature of SI-PET-RAFT polymerization in FIG. 3 demonstrated that a predictable film thickness can be produced based on the time of reaction.

FIG. 4 shows the height profile for striped patterned films of POSS-acrylate brushes grown by SI-PET-RAFT, demonstrating that the 5 μm striped pattern fidelity was maintained after curing with the corresponding change in feature thickness associated with consolidation into glassy SiOₓ features.

All X-ray Photoelectron Spectroscopy (XPS) measurements were performed with a Physical Electronics PHI Quantum 2000 XPS instrument equipped with monochromatized Al Kα radiation and used a combination of low energy electrons and Argon ions for charge neutralization. During the XPS measurements, an approximately 100 micrometer wide monochromatized Al Kα beam with a beam energy of approximately 25 watts was rastered over the probed area, which was 1 mm×0.5 mm in size. For each example, 2 such areas were measured on each analyzed surface. The areas were at least 1 centimeter apart. The compositions calculated are the average for both areas, and the error bars are the standard deviations. The pass energy of the spectrometer was set to a value of 46.95 eV with a step size of 0.1 eV/step and a dwell time of 50 milliseconds per step. The core levels monitored during the XPS measurements are listed in the order in which they were measured along with the number of scans that each core level was measured: O 1s (4 scans), Si 2p (3 scans), C 1s (3 scans), and Na 1s (3 scans).

The data analysis was performed using the MULTIPAK™ software package (Version 9.4.0.7; Ulvac-phi, Inc.). During analysis, the energy scale was referenced to the C—C/C—H peak of hydrocarbons set at the commonly accepted value of 284.8 eV. Compositional analysis was performed using the atomic sensitivity factors provided in the version of MULTIPAK™ software providing surface composition in atomic percent.

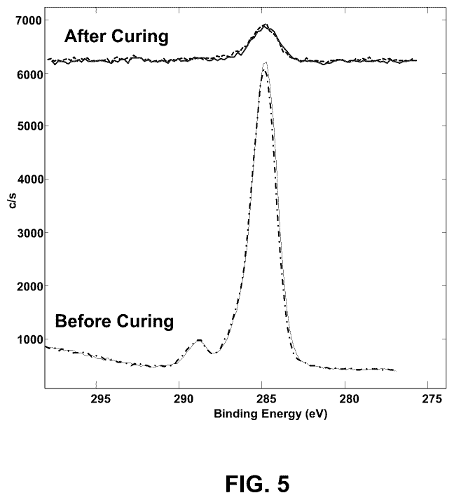

An XPS spectrum (FIG. 5) shows peaks associated with carbon species for a POSS-methacrylate film grown by SI-PET-RAFT and cured SiOₓ glassy films, demonstrating a substantial reduction in the organic (carbon) containing compounds after curing. Residual low-level carbon species detected in the cured sample are consistent with small levels of organic contaminants.

ToF-SIMS data were acquired using an IONTOF M6 instrument equipped with a Bi LMIG (liquid metal ion gun) analysis source and both Cs and Ar gas cluster ion beam (GCIB) sputter sources. All mass spectral data were acquired using a 30 keV Bi₃⁺ primary ion beam for analysis operated at a 350 μs cycle time with a 20 ns pulse width. A 400 μm beam defining aperture was used, yielding a pulsed beam current of ˜0.08 pA. The mass spectra were acquired using a random raster with a 128×128 pixel density and a raster size of 200 μm×200 μm. This yields a primary ion dose density of 2.3×10¹¹ ions/cm². Data were acquired after a gentle sputter cleaning cycle with a 5 keV Ar GCIB source operated for 12 s using a 750 μm×750 μm beam raster and a beam current of 4 nA continuous current. The Ar GCIB was operated using a cluster size of approximately 1200 Ar atoms. This cleaning step was used to remove any surface contamination that might interfere with the analysis. A low energy flood gun, and Ar gas flooding were utilized during the analysis for charge compensation. All depth profiles were acquired in non-interlaced mode using the Bi₃⁺ source for analysis, operated using the conditions described above, in conjunction with a 2 keV Cs source for sputtering. A single scan of the Bi₃⁺ ion beam was alternated with a short sputter interval with the Cs source (1.3 s for uncured film and 0.5 s for cured film). The Cs source was operated at 50 nA continuous current, with a raster of 750 μm×750 μm.

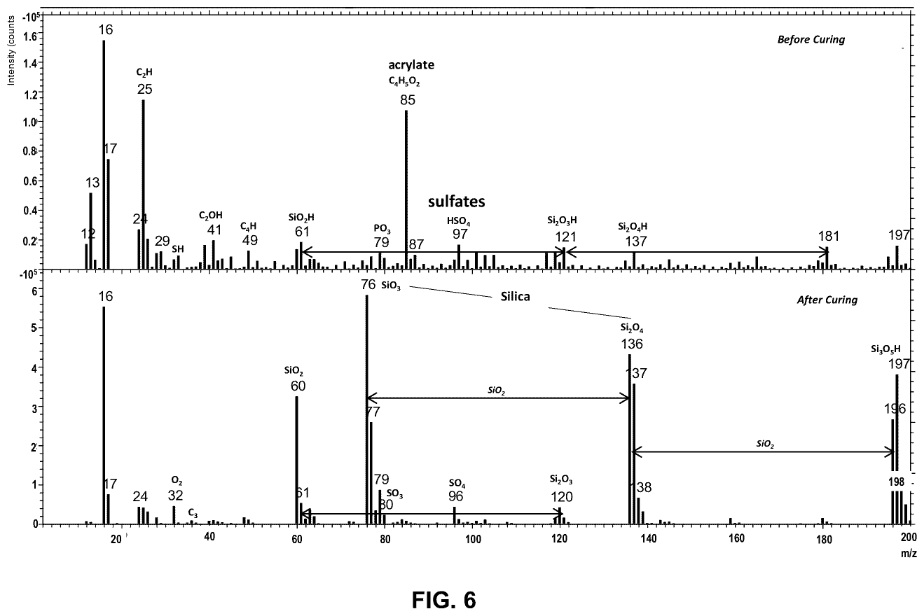

A ToF-SIMS negative ion spectrum (FIG. 6) for a film grown by SI-PET-RAFT demonstrates a substantial reduction in the organic containing compounds after curing, leaving a SiOₓ rich layer consistent with the conversion of POSS-methacrylate into glassy SiOₓ features.

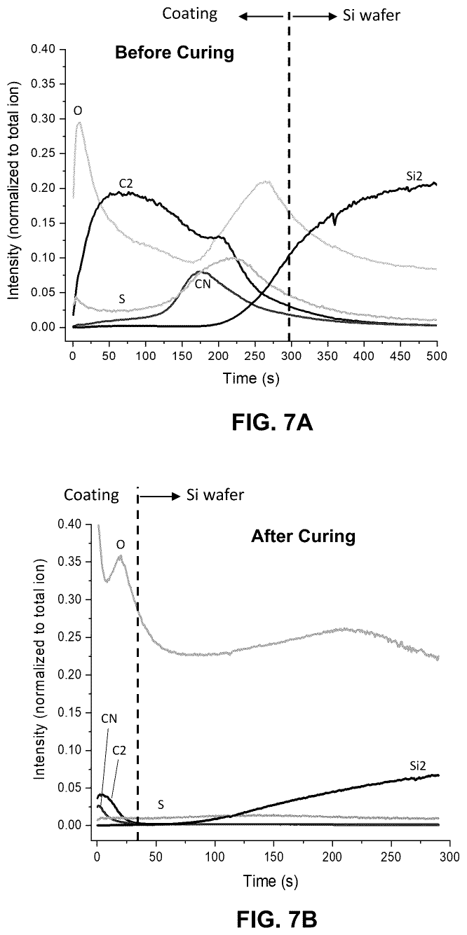

A negative ion depth-profiling ToF-SIMS spectrum (FIGS. 7A and 7B) for a film grown by SI-PET-RAFT demonstrated a substantial reduction in the organic containing compounds after curing, leaving a SiOₓ rich layer consistent with the conversion of POSS-methacrylate into glassy SiOₓ features. Furthermore, the —CN species associated with the RAFT chain-transfer agent was observed to be located near the surface, as expected for the SI-PET-RAFT growth mechanism.

### Example 3

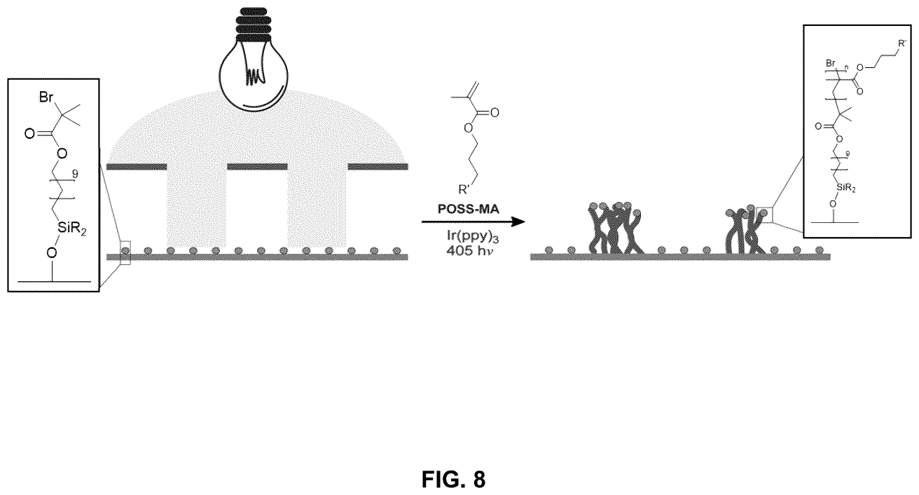

A surface-initiated atom transfer radical polymerization (SI-ATRP) via light mediation was prepared on a substrate using POSS-MA, as illustrated in FIG. 8.

To polymerize methacryloisobutyl polyhedral oligomeric silsesquioxanes (POSS-MA) via SI-ATRP, tris(2-phenylpyridine) iridium [Ir(PPy)₃] was used as a photocatalyst (PC). A stock solution containing 0.08 mg of [Ir(PPy)₃] in 1 mL of toluene was prepared and stored. The monomer was mixed with the PC stock solution with a mole ratio of [POSS-MA]:[PC]=250:0.0125 in a 4 mL vial. The reaction mixture then degassed with nitrogen for 10 min. The reaction mixture was pipetted on to an ATRP-functionalized glass slide. A cover slip was placed on top to form a uniform layer of monomer mixture. Finally, the glass slide was irradiated with 405 nm wavelength light for a required amount of time. After the reaction completion, glass slides were thoroughly washed with toluene followed by isopropanol and dried under a stream of nitrogen.

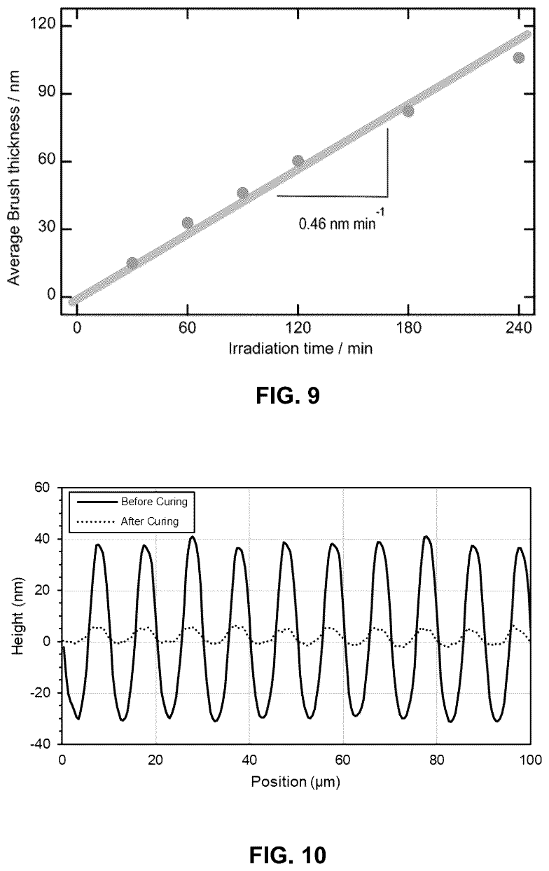

The living nature of SI-ATRP in FIG. 9 demonstrated that a predictable film thickness can be produced based on the time of reaction. Optical micrographs of patterned films by SI-ATRP demonstrated that a color change was associated with the interaction of light with features of different aspect ratios due to differing heights.

FIG. 10 shows the height profile for striped patterned films of POSS-acrylate brushes grown by SI-ATRP, demonstrating that the 5 μm striped pattern fidelity was maintained after curing with the corresponding change in feature thickness associated with consolidation into glassy SiOₓ features.

It is to be appreciated that the Detailed Description section, and not the Summary and Abstract sections, is intended to be used to interpret the claims. The Summary and Abstract sections may set forth one or more but not all exemplary aspects of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the invention that others can, by applying knowledge within the skill of the art, readily modify and/or adapt for various applications such specific aspects, without undue experimentation, without departing from the general concept of the present invention. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary aspects, but should be defined only in accordance with the following claims and their equivalents.

The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, the Examiner is also reminded that any disclaimer made in the instant application should not be read into or against the parent application.

What is claimed is:

1. A method of forming a nanostructure, comprising:
providing a first polymeric brush structure attached to at least one surface of a substrate, wherein the first polymeric brush structure comprises a pre-glass polymerizable precursor; and
curing the first polymeric brush structure to form a nanostructure comprising glass.

2. The method of claim 1, wherein the first polymeric brush structure is attached to the at least one surface of the substrate through a surface anchoring group on the first polymeric brush structure.

3. The method of claim 2, wherein prior to attachment, the surface anchoring group is a silyl, hydroxy, thiol, alkenyl, alkynyl, alkoxy, carboxy, hydroxamic acid, amino, azido, halide, phosphono, or sulfonato.

4. The method of claim 3, wherein prior to attachment, the surface anchoring group is a silyl of the formula SiRₓA_{y}B, where R is a non-reactive group, A is a group that can react with the surface of the substrate, B is a pendant group capable of participating in a coupling reaction, x is an integer of 0, 1, or 2, y is an integer of 1, 2, or 3, wherein x+y=3.

5. The method of claim 1, wherein the substrate comprises at least one reactive group on the at least one surface and comprises a glass, a metal oxide, a metal, carbon, silicon, a polymer, or any combination thereof.

6. The method of claim 2, wherein the pre-glass polymerizable precursor is connected to the surface anchoring group by a linker.

7. The method of claim 6, wherein the linker comprises an alkyl chain optionally substituted with one or more of NH, O, S, C(O), or any combination thereof.

8. The method of claim 7, wherein the linker is a C₁-C₁₀ alkyl chain.

9. The method of claim 6, wherein the first polymeric brush structure is formed by a photoelectron transfer polymerization process comprising a photoredox catalyst.

10. The method of claim 9, wherein the first polymeric brush structure is formed by reacting (i) at least one vinyl-containing group comprising a pre-glass precursor with (ii) a polymerization active group on the linker comprising a reversible addition-fragmentation chain-transfer (RAFT) agent or an atom transfer radical polymerization (ATRP) initiator.

11. The method of claim 10, wherein the pre-glass precursor is silicon-based, titanium-based, zirconium-based, aluminum-based, cerium-based, or any combination thereof.

12. The method of claim 10, wherein the pre-glass precursor comprises SiOx, TiOx, ZrOx, or any combination thereof.

13. The method of claim 12, wherein the pre-glass precursor comprises a silsesquioxane.

14. The method of claim 1, wherein the pre-glass polymerizable precursor is a polyoctahedral silsesquioxane (POSS) comprising at least one vinyl-containing group.

15. The method of claim 1, wherein the nanostructure comprises about 10 atomic % or less of carbon.

16. The method of claim 1, further comprising forming the first polymeric brush structure by contacting (i) at least one vinyl-containing group comprising a pre-glass precursor with (ii) a polymerization active group comprising a reversible addition-fragmentation chain-transfer (RAFT) agent or an atom transfer radical polymerization (ATRP) initiator, in the presence of a redox catalyst;
optionally further comprising attaching the polymerization active group to a linker; and
optionally further comprising attaching the linker to the at least one surface of the substrate by reacting a surface anchoring group attached to the linker with at least one reactive group on the at least one surface.

17. The method of claim 1, further comprising providing a second polymeric brush structure, wherein the first polymeric brush structure is different from the second polymeric brush structure, and then curing both the first polymeric brush structure and the second polymeric brush structure to form nanostructures comprising glass.

18. A substrate, comprising:
a surface comprising a plurality of nanostructures comprising glass,
wherein at least a portion of the nanostructures comprises a detectable amount of carbon by x-ray photoelectron spectroscopy (XPS).

19. The substrate of claim 18, wherein the detectable amount of carbon is less than 20 atomic %.

20. The substrate of claim 18, wherein the nanostructures have an average diameter of about 1 nm to about 10 μm and an average height of about 1 nm to 300 nm.
